(19) United States
(12) Patent Application Publication
(10) Pub. No.: US 2005/0174583 A1
(43) Pub. Date: Aug. 11, 2005

(54) Method and apparatus for high-speed thickness mapping of patterned thin films

(76) Inventors: Scott A. Chalmers, La Jolla, CA (US); Randall S. Geels, El Cajon, CA (US)

Correspondence Address: HOWREY SIMON ARNOLD & WHITE, LLP - OC, 301 RAVENSWOOD AVENUE, BOX 34, MENLO PARK, CA, 94025, US

(21) Appl. No.: 11/056,350

(22) Filed: Feb. 10, 2005

Related U.S. Application Data
(63) Continuation-in-part of application No. 09/899,383, filed on Jul. 3, 2001.
Application No. 09/899,383 is a continuation-in-part of application No. 09/611,219, filed on Jul. 6, 2000, now abandoned.
(60) Provisional application No. 60/543,506, filed on Feb. 11, 2004.

(51) Int. Cl. G01B 11/28

(52) U.S. Cl. 356/630

(57) ABSTRACT

An apparatus or method captures reflectance spectrum for each of a plurality of spatial locations on the surface of a patterned wafer. A spectrometer system having a wavelength-dispersive element receives light reflected from the locations and separates the light into its constituent wavelength components. A one-dimensional imager scans the reflected light during translation of the wafer with respect to the spectrometer to obtain a set of successive, spatially contiguous, one-spatial dimension spectral images. A processor aggregates the images to form a two-spatial dimension spectral image. One or more properties of the wafer, such as film thickness, are determined from the spectral image. The apparatus or method may generate a wavelength-dependent correction factor to correct for diffraction errors introduced in reflectance spectra by the wavelength-dispersive element. The invention provides for automatic rotation of a patterned wafer to determine Goodness of Alignment during a measurement process. The invention may include a dual Offner optical system disposed between the wafer and imager.

This application claims benefit of U.S. Provisional Application 60/543,506 filed Feb. 11, 2004, which is hereby fully incorporated by reference herein as though set forth in full.

This application is a continuation-in-part of U.S. patent application Ser. No. 09/899,383, filed Jul. 3, 2001, which is a continuation-in-part of U.S. patent application Ser. No. 09/611,219, filed Jul. 6, 2000, both of which are hereby fully incorporated by reference herein as though set forth in full.

### BACKGROUND OF THE INVENTION

This invention relates generally to the field of film thickness measurement, and more specifically, to the field of film measurement in an environment, such as semiconductor wafer fabrication and processing, on which a layer with an unknown thickness resides on a patterned sample.

Many industrial processes require precise control of film thickness. In semiconductor processing, for example, a semiconductor wafer is fabricated in which one or more layers of material from the group comprising metals, metal oxides, insulators, silicon dioxide (SiO₂), silicon nitride (SiN), polysilicon or the like, are stacked on top of one another over a substrate, made of a material such as silicon. Often, these layers are added through a process known as chemical vapor deposition (CVD), or removed by etching or removed by polishing through a process known as chemical mechanical polishing (CMP). The level of precision that is required can range from 0.0001 μm (less than an atom thick) to 0.1 μm (hundreds of atoms thick).

To determine the accuracy of these processes after they occur, or to determine the amount of material to be added or removed by each process, it is advantageous to measure the thickness of the layers on each product wafer (i.e., on each wafer produced that contains partially processed or fully processed and saleable product), which is generally patterned with features on the order of 0.1 μm to 10 μm wide. Because the areas covered by these features are generally unsuitable for measurement of film properties, specific measurement sites called “pads” are provided at various locations on the wafer. To minimize the area on the wafer that is taken up by these measurement pads, they are made to be very small, usually about 100 μm by 100 μm square. This small pad size presents a challenge for the film measurement equipment, both in measurement spot size and in locating the measurement pads on the large patterned wafer. A measurement spot size of an optical system refers to the size of a portion of an object being measured that is imaged onto a single pixel of an imaging detector positioned in an image plane of the optical system.

To date, though its desirable effects on product yield and throughput are widely recognized, thickness measurements are only made after certain critical process steps, and then generally only on a small percentage of wafers. This is because current systems that measure thickness on patterned wafers are slow, complex, expensive, and require substantial space in the semiconductor fabrication cleanroom.

Spectral reflectance is the most widely used technique for measuring thin-film thickness on both patterned and unpatterned semiconductor wafers. Conventional systems for measuring thickness on patterned wafers employ high-magnification microscope optics along with pattern recognition software and mechanical translation equipment to find and measure the spectral reflectance at predetermined measurement pad locations. Examples of this type of system are those manufactured by Nanometrics, Inc., and KLA-Tencor. Such systems are too slow to be used concurrently with semiconductor processing, so the rate of semiconductor processing must be slowed down to permit film monitoring. The result is a reduced throughput of semiconductor processing and hence higher cost.

A newer method for measuring thickness of patterned films is described in U.S. Pat. No. 5,436,725. This method uses a CCD camera to image the spectral reflectance of a full patterned wafer by sequentially illuminating the wafer with different wavelengths of monochromatic light. Because the resolution and speed of available CCD imagers are limited, higher magnification sub-images of the wafer are required to resolve the measurement pads. These additional sub-images require more time to acquire and also require complex moving lens systems and mechanical translation equipment. The result is a questionable advantage in speed and performance over traditional microscope/pattern recognition-based spectral reflectance systems.

Ellipsometry is another well-known technique for measuring thin film thickness. This technique involves measuring the reflectance of p-polarized and s-polarized light incident on a sample. Systems exploiting this technique include a light source, a first polarizer to establish the polarization of light, a sample to be tested, a second polarizer (often referred to as an analyzer) that analyzes the polarization of light reflected from the sample, and a detector to record the analyzed light. Companies such as J. A. Woolam, Inc. (Lincoln, Nebr.) and Rudolph Technologies, Inc. (Flanders, N.J.) manufacture ellipsometer systems.

Accordingly, it is an object of the present invention to provide a method and apparatus for achieving rapid measurement of film thickness and other properties on patterned wafers during, between, or after semiconductor processing steps.

An additional object is a method and apparatus for film measurement that is capable of providing an accurate measurement of film thickness and other properties of individual films in a multi-layered or patterned sample.

An additional object is a method and apparatus for film measurement that is capable of providing an accurate measurement of film thickness and other properties of individual films in a multi-layered or patterned sample based on image analysis.

A further object is an optical method and apparatus for thin-film measurement that overcomes the disadvantages of the prior art.

Further objects of the subject invention include utilization or achievement of the foregoing objects, alone or in combination. Additional objects and advantages will be set forth in the description which follows, or will be apparent to those of ordinary skill in the art who practice the invention.

### SUMMARY OF THE INVENTION

The invention provides a spectrometer configured to simultaneously capture a reflectance spectrum for each of a plurality of spatial locations on the surface of a sample. The spectrometer includes a wavelength-dispersive element, such as a prism or diffraction grating, for receiving light representative of the plurality of spatial locations, and separating the light for each such location into its constituent wavelength components. The spectrometer further includes an imager for receiving the constituent wavelength components for each of the locations, and determining therefrom the reflectance spectrum for each location.

The invention also provides a system for measuring one or more properties of a layer of a sample. The system includes a light source for directing light to the surface of the layer at an angle that deviates from the layer normal by a small amount. Also included is a sensor for receiving light reflected from and representative of a plurality of spatial locations on the surface of the layer, and simultaneously determining therefrom reflectance spectra for each of the plurality of spatial locations on the surface. The system also includes a processor for receiving at least a portion of the data representative of the reflectance spectra for each of the plurality of spatial locations and determining therefrom one or more properties of the layer.

The invention also provides a method for measuring one or more properties of a layer of a sample. The method includes the step of directing light to a surface of the layer. It also includes the step of receiving light at a small angle reflected from the surface of the layer, and determining therefrom reflectance spectra representative of each of a plurality of spatial locations on the surface of the layer. The sample may be relatively translated with respect to the directed and received light until reflectance spectra for all or a substantial portion of the layer have been determined. One or more properties of the layer may be determined from at least a portion of the reflectance spectra for all or a substantial portion of the layer.

The invention further provides a system of and method for measuring at least one film on a sample from light reflected from the sample having a plurality of wavelength components, each having an intensity. A set of successive, spatially contiguous, one-spatial-dimension spectral reflectance images may be obtained by scanning the wafer with a one-spatial-dimension spectroscopic imager. The resulting series of one-spatial-dimension spectral images may be arranged to form a two-spatial-dimension spectral image of the wafer. The spectral data at one or more of the desired measurement locations may then be analyzed to determine a parameter such as film thickness.

In another embodiment, the invention provides an apparatus or method for correcting for second order diffraction errors introduced in reflectance spectra by the wavelength-dispersive element. A detector having a sensitivity range between a wavelength and a cutoff wavelength is configured to receive light diffracted from the wavelength-dispersive element. A processor coupled to the detector records first and second-order reflectance intensities and calculates a ratio of the first-order reflectance intensity to the second-order reflectance intensity. Based on the ratio, the processor calculates a wavelength-dependent correction factor for any wavelength within the sensitivity range of the detector. The recorded first-order reflectance intensity may then be modified according to the correction factor, and one or more properties of the wafer may be determined from the corrected reflectance intensity.

In another embodiment, the invention provides a method for aligning an image of a patterned wafer and determining a Goodness-of-Alignment (GOA) value. The method comprises providing an image of the wafer and assigning the image an initial alignment angle. A GOA value is determined for the image in its initial alignment based on analysis of spectral reflectance data. The image is then rotated by an incremental angle, and another GOA value is determined and recorded. Successive incremental rotations and GOA values are made and recorded until a desired rotation angle is achieved. A maximum GOA value and optimal rotation angle associated with the maximum GOA value are then determined from the recorded data. In one aspect, the image comprises a plurality of rows of reflectance measurements, and GOA values are determined by: summing reflectance measurements in two or more rows to form a column of row sums; detecting the contrast between one or more pairs of adjacent row sums; and computing the GOA value for each alignment angle according to the detected contrast.

A further embodiment of the invention comprises an apparatus or method for producing a line image of a patterned wafer using a dual Offner optical system. A first Offner group having a first focal point and a second focal point is configured such that the first focal point coincides with the portion of the wafer being imaged. A second Offner group having a third focal point and a fourth focal point is configured such that the third focal point coincides with the second focal point. A slit is disposed in a plane perpendicular to the direction of propagation of light at the second focal point. Finally, a one-dimensional imaging system is configured such that its focal point coincides with the fourth focal point to capture the reflectance spectra of the portion of the wafer being imaged. In one aspect, the dual Offner optical system is coupled to an imaging system comprising a processor that aggregates reflectance spectra to obtain a spectral image of the wafer.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a first embodiment of a system in accordance with the subject invention.

FIG. 2 illustrates in detail the optical subsystem of the embodiment shown in FIG. 1.

FIG. 3 illustrates a second embodiment of a system in accordance with the subject invention.

FIG. 4 illustrates an embodiment of a method in accordance with the subject invention.

FIG. 5A is a top view of an example semiconductor wafer showing desired measurement locations.

FIG. 5B is a side view of an example semiconductor wafer showing stacked layers each configured with one or more precise features.

FIG. 6A illustrates a commercial embodiment of a system according to the invention.

FIG. 6B illustrates aspects of the optical path of the system of FIG. 6A.

FIG. 7 illustrates an example of a reflectance spectrum for a location on the surface of a semiconductor wafer.

FIG. 8 illustrates a cross section of the fiber bundle of the system of FIG. 6A.

FIG. 9A depicts the one-spectral, two-spatial dimensional data that is captured for an individual layer in the system of FIG. 6A.

FIG. 9B shows the ensemble of one-spectral, two-spatial dimensional data that together forms a spectral image.

FIG. 10A illustrates the area surrounding a desired measurement location in which matching is performed in the system of FIG. 6A.

FIG. 10B illustrates the corresponding image of the desired measurement location in FIG. 10A.

FIG. 11 is a flowchart of an embodiment of a method of operation in the system of FIG. 6A.

FIG. 12 illustrates an embodiment of a spectral ellipsometric system in accordance with the subject invention.

FIG. 13 illustrates an embodiment of a variable angle spectral ellipsometric system in accordance with the subject invention.

FIG. 14A illustrates the illumination of patterned features with broad angle, large numerical aperture light according to the system in accordance with the prior art.

FIG. 14B illustrates the illumination of patterned features with shallow angle, small numerical aperture light according to the system in accordance with the subject invention.

FIG. 15 shows measurements of erosion using the system in accordance with the subject invention.

FIG. 16A is a flowchart showing a method of compensating for second order spectral overlap using the apparatus of the subject invention.

FIG. 16B illustrates an embodiment of a method according to the invention for correcting for second order diffraction errors in reflectance spectra.

FIG. 17 shows the spectral response with and without compensation for second order spectral overlap.

FIG. 18 shows the correction factor for compensation for second order spectral overlap.

FIG. 19 shows an image of a round wafer undergoing non-uniform motion during the measurement.

FIG. 20A is a graphic illustration of GOA determination using row and column summation.

FIG. 20B shows an example of Goodness-of-Alignment values as a function of rotational angle θ using the auto-rotate algorithm of the present invention.

FIG. 20C illustrates one embodiment of a method according to the invention for aligning an image of a patterned wafer.

FIG. 21 illustrates a second embodiment of a spectral ellipsometric system in accordance with the subject invention.

FIG. 22 shows measurement spot size for 100% fill factor imaging for (A) optimal wafer orientation, and (B) worst-case wafer orientation.

FIG. 23 shows how to mask individual pixels according to the present invention.

FIG. 24 shows measurement spot size for <100% fill factor imaging resulting from the use of masked pixels for (A) optimal wafer orientation, and (B) worst-case wafer orientation.

FIG. 25 illustrates the use of over-sampling to enhance vertical pixel image density using masked pixels according to the present invention.

FIG. 26 shows the technique of row staggering based on the use of masked pixels to enhance the horizontal pixel image density according to the present invention.

FIG. 27 shows a wafer paddle motion dampening system.

FIG. 28 shows the integration of a process chamber viewport into the optical system of the line imaging spectrometer according to the present invention.

FIG. 29 shows a dual-Offner imaging system for enhancing the quality of images recorded with the line imaging spectrometer of the present invention.

### DETAILED DESCRIPTION OF THE PREFERRED EMBODIMENTS

### A First Embodiment

### System for Measurements at an Angle

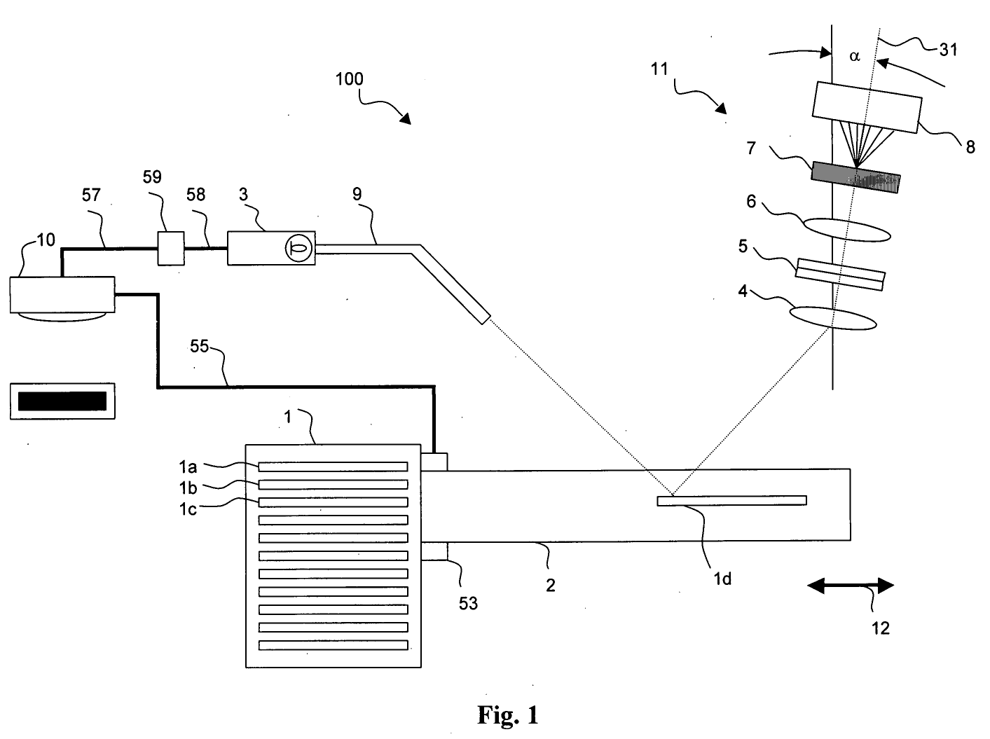

A first embodiment of an imaging system 100 in accordance with the subject invention, suitable for use in applications such as measuring the thickness of transparent or semi-transparent films, is illustrated in FIG. 1. Advantageously, the film to be measured ranges in thickness from 0.001 μm to 50 μm, but it should be appreciated that this range is provided by way of example only, and not by way of limitation. This embodiment is advantageously configured for use with a wafer transfer station 1 to facilitate rapid measurement of a cassette of wafers. The station houses a plurality of individual wafers 1a, 1b, 1c, and is configured to place a selected one of these wafers, identified with numeral 1d in the figure, onto a platform 2. Each of wafers 1a, 1b, 1c, and 1d has a center point and an edge. This embodiment also comprises a light source 3 coupled to an optical fiber 9 or fiber bundle for delivering light from the light source 3 to the wafer 11d situated on platform 2. Preferably, the light source 3 is a white light source. Advantageously, the light source 3 is a tungsten-halogen lamp or the like in which the output is regulated so that it is substantially invariant over time. For purposes of illustration, this embodiment is shown being used to measure the thickness of film on wafer 1d, which together comprises a sample, but it should be appreciated that this embodiment can advantageously be employed to measure the thickness of individual films in samples comprising multi-layer stacks of films, whether patterned or not. Light source 3 may optionally include a diffuser disposed between light source 3 and optical fiber 9 to even out light source non-uniformities so that light entering optical fiber 9 is uniform in intensity.

The first embodiment of imaging system 100 further includes a line imaging spectrometer 11 comprising a lens assembly 4, a slit 5 having a slit width, a lens assembly 6, a diffraction grating 7, and a two-dimensional imager 8. Line imaging spectrometer 11 has an optical axis 31, and is disposed in imaging system 100 so that optical axis 31 is aligned at a small angle α to the wafer 1d normal. Lens assembly 4 and lens assembly 6 each have a magnification.

Two-dimensional imager 8 has an integration time during which it absorbs light incident upon it to create a detected signal. This integration time is selectable over a broad range of values with preferred values being 10 to 1000 us.

Angle α defines near normal incidence, and can be as small as 0 degrees or as large as that given by the Brewster angle of the topmost layer, but preferably the angle oa is approximately 2 degrees. A range of angles from 0 to Brewster angle allows one or more measurements at angle α, which provides greater information. The angle α L lies in a measurement plane that, if aligned with an array of conductive metal lines, results in improved measurements. Measurements obtained at such an angle are uniquely capable of determining the thickness of films in finely patterned areas with feature dimensions on the order of the wavelength of the light being used. This capability results from reduced interaction with the feature sidewalls than with angled (and thus high NA) reflectance measurements such as those provided by microscope optics or the apparatus described in U.S. Pat. No. 5,436,725. The small NA (0.01 to 0.05 is typical) and near normal incidence measurements provided by the apparatus of the present invention are not as sensitive to (and therefore not thrown off by), for example, variations in metal line widths and sidewall angles when measuring oxide erosion caused by chemical-mechanical polishing. The small NA and near normal incidence measurements provided by the apparatus of the present invention also result in a much greater depth-of-field than conventional patterned-wafer measurement systems have, which allows for measurements to be made without precision z-motion (height) mechanisms or point-to-point or wafer-to-wafer focus adjustments, as are necessary with other methods.

System 100 further includes a translation mechanism 53 that is mechanically connected to platform 2 and serves to move platform 2 holding wafer 1d. In accordance with commands from computer 10, translation mechanism 53 causes platform 2 to move.

Computer 10 is also electrically connected to a synchronization circuit 59 via an electrical connector 57. Synchronization circuit 59 in turn is electrically connected to light source 3. Upon command from computer 10 via electrical connection 57, synchronization circuit 59 sends one or more synchronization signals to light source 3 that cause light source 3 to emit one or more pulses of light. By coordinating motion of wafer 1d and the synchronization signals sent to synchronization circuit 59, minimally sized illumination spots are formed on wafer 1d.

In the absence of relative motion of wafer 1d, each of the one or more pulses of light forms a small spot on wafer 1d, where the size of each spot is determined largely by the specific design configuration of line imaging spectrometer 11 and the pixel dimensions of two-dimensional imager 8. The nominal size of each measurement spot is approximately 50 um. However, when wafer 1d is in motion and light from light source 3 is emitted continuously, each spot is elongated and the area from which light is detected increases.

A scan time is defined as the time necessary for system 100 to acquire data from the regions of interest of wafer 1d, i.e. by sequentially imaging areas across wafer 1d. A scan speed is the scan time divided by the length of the area being measured. For example, if entire wafer 1d is the scan area, and 5 seconds is the scan time, then the scan speed is 40 mm/s, assuming a 200 mm diameter wafer. Note that scan speed refers to the speed with which an area on wafer 1d is being imaged moves across wafer 1d; whether wafer 1d or light source 3 or line imaging spectrometer 11 moves does not matter.

With two-dimensional imager 8 having a 1 ms integration time in the example above, the measurement spot for each measurement sweeps across an additional portion of wafer 1d that extends for 40 um. This additional distance causes the detected reflectance spectrum to be a mixture of whatever film stacks the spot passed over during the integration time. However, by using short pulses of light, the additional distance is reduced. For example, a 10 us pulse width means that the additional distance less than 1 um, which is significantly less than the nominal spot size of 50 um.

Imaging system 100 operates as follows. Light from source 3 passes through fiber bundle 9, and impinges on a film contained on or in wafer 1d. The light reflects off the wafer and is received by lens assembly 4. Lens assembly 4 focuses the light on slit 5. Slit 5 receives the light and produces a line image of a corresponding line on the wafer 1d. The line image is arranged along a spatial dimension. The line image is received by second lens assembly 6 and passed through diffraction grating 7. Diffraction grating 7 receives the line image and dissects each subportion thereof into its constituent wavelength components, which are arranged along a spectral dimension. In one implementation, the spectral dimension is perpendicular to the spatial dimension. The result is a two-dimensional spectral line image that is captured by two-dimensional imager 8 during the integration time. In one implementation, the imager is a CCD, the spatial dimension is the horizontal dimension, and the spectral dimension is the vertical dimension. In this implementation, the spectral components at each horizontal CCD pixel location along the slit image are projected along the vertical dimension of the CCD array.

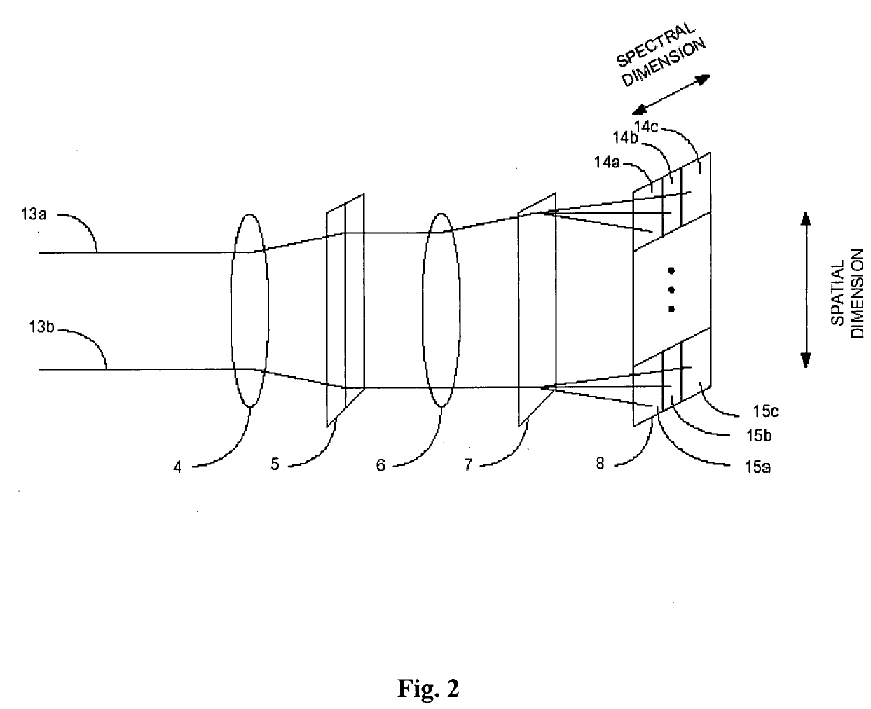

Additional detail regarding line imaging spectrometer 11 is illustrated in FIG. 2 in which, compared to FIG. 1, like elements are referenced with like identifying numerals. As illustrated, reflected light (for purposes of illustration, two rays of reflected light, identified with numerals 13a and 13b are shown separately) from wafer 1d is received by lens assembly 4 and focused onto slit 5. Slit 5 forms a line image of the light in which the subportions of the line image are arranged along a spatial dimension. The line image is directed to lens assembly 6. Lens assembly 6 in turn directs the line image to diffraction grating 7. Diffraction grating 7 dissects each subportion of the line image into its constituent wavelength components. The wavelength components for a subportion of the line image are each arranged along a spectral dimension. Two-dimensional imager 8 individually captures the wavelength components for the subportions of the line image during the integration time. Thus, the wavelength components for ray 13a are individually captured by pixels 14a, 14b, and 14c, respectively. Similarly, the wavelength components for ray 13b are individually captured by pixels 15a, 15b, and 15c, respectively. Imager 8 is preferably designed so that the vast majority of photons landing upon individual pixels wind up storing electrical charge only within the pixels that they land on. For example, common CCD design allows photons with large penetration depths (i.e., photons with long wavelength) to generate electrons far beneath the pixels that they land on, and then allows these electrons to wander up and to be collected by pixels neighboring the pixel that the photons originally entered the CCD through. This causes a reduction in image resolution and an increase in the apparent measurement spot size, but can be substantially reduced by proper CCD design (by reducing the migration length of electrons below the pixels, for example.)

With reference to FIG. 1, light source 3 and platform 2 are moveable relative to one another. In addition, platform 2 and line imaging spectrometer 11 are moveable in relation to one another. In one implementation, light source 3 and line imaging spectrometer 11 are stationary, and the platform is moveable in an X direction 12.

Since the apparatus of the present invention is capable of obtaining a large number of measurements, large quantities of data must be dealt with. One way to limit the extent of such data is to move platform 2 in a non-linear fashion. For example, platform 2 can be moved in a large translational step to one particular location, then move in smaller translational steps over a region of wafer 1d where measurements are desired. Platform 2 can then make another large translational step to another region of wafer 1d where more measurements are desired, and so on.

In operation, computer 10 sends commands to translation stage 53 that cause wafer 1d on platform 2 on wafer station 1 to move. When wafer 1d is positioned in a desired location, computer 10 sends synchronization commands to synchronization circuit 59, which cause light source 3 to emit pulses of light that propagate fiber bundle 9 to wafer 1d. Computer 10 also sends configuration commands to two-dimensional imager 8 that include the integration time and a command to initiate data collection. The pulses of light emitted by light source 3 are short enough compared to the speed of wafer 1d that the light collected by line imaging spectrometer 11 comes from a minimally sized spot on wafer 1d. Furthermore, the pulses of light from light source 3 are synchronized with the integration time and the data acquisition command so that each pulse is emitted only during the integration time. Line imaging spectrometer 11 in turn communicates the spectral and spatial information to computer 10 over one or more signal lines or through a wireless interface. Spectral reflectance data is continually taken in this way while wafer 1d is moved under line imaging spectrometer 11 by platform 2 under the action of translation stage 53 and upon command from computer 10.

Once the entire area of interest has been scanned in this manner, computer 10 uses the successively obtained line images of one-spatial-dimension data to generate a two-spatial-dimension image. This plurality of spectral reflectance images comprises a “spectral image”. Thus, the spectral image may comprise a two-dimensional map that may be generated, for example, by assembling the measured signal intensities at a single wavelength at each location on the wafer into an image, while retaining the spatial relationship between image locations within each scan and from one contiguous scan line to the next. This two-dimensional image can then be analyzed to find pixels that correspond to specific locations on the wafer. Then, the spectral reflectance data that is associated with these pixels can be analyzed using suitable techniques to arrive at an accurate estimate of the thickness of the film. Typically, film thickness is determined by matching the measured spectrum to a theoretically or experimentally determined set of spectra representing layers of differing thicknesses.

In the foregoing embodiment, although a CCD-based one-spatial-dimension imaging spectrometer is illustrated and described as the means for determining the intensity of reflected light as a function of wavelength, it should be appreciated that other means are possible for performing this function, and other types of one-spatial-dimension imaging spectrometers are possible than the type illustrated in the figures.

The foregoing embodiment is described with a preferred way of forming minimally sized spots on each wafer by synchronizing the emission of pulses of light with the integration time of two-dimensional imager 8 and with wafer motion. However, alternate approaches that compensate for the relative wafer-to-imager motion also achieve the same ends. One such alternative approach is to use an electrically actuated “wafer tracking” mirror disposed within system 100 between imaging system 11 and the wafer 1d. In this alternative approach, the electrically actuated mirror includes a piezoelectric element mechanically connected to one edge of the mirror while the center of the mirror is secured to form a hinge that allows rotational motion about the center axis of the mirror so that the focal distance between the imaging system 11 and the wafer 1d remains substantially the same. Upon applying an electrical signal to the piezoelectric element, the electrically actuated mirror then deflects the light between wafer 1d and the imaging system 11 such that the imaging system tracks the wafer motion during each integration period. Between integration periods, the mirror position is reset to begin tracking the proper wafer location for the following integration time. Similar “wafer tracking” capabilities may be realized by displacing other optical elements, such as the slit 5.

Although the foregoing embodiments are described in the context of semiconductor wafers, and are illustrated in combination with a wafer transfer station for performing this function, skilled artisans will appreciate that it is possible to employ these embodiments in other contexts and in combination with other processing apparatus. Other possible applications include providing thin film scratch resistant and/or antireflective optical coatings to automotive plastics, eyeglass lenses, and the like, plastics packaging applications, and applications such as providing appropriate polyimide and resist thicknesses for manufacturing flat panel displays. In fact, the present invention may be applied to any industrial process in which precision film measurement is desired.

Another advantage of the foregoing embodiments is that they are particularly well suited for real-time applications. The reason is that data collection steps employing time-consuming angular or mechanical sweeps of optical components as found in the prior art are eliminated. For example, in the subject embodiment, the line imaging spectrometer directly provides digitized values of intensity of the incoming light as a function of wavelength without requiring mechanical sweeping steps. Also, digital CCD-based line-scan cameras are available with sufficient numbers of pixels so that resolution of measurement pads is possible. In addition, the number of analytical and pattern recognition steps performed by the computer are limited to only a very few. This is because an image of the entire wafer is made, which eliminates complicated pattern recognition routines that are needed when only small areas of wafers are viewed at any one time, as is the case with microscope-based instruments.

### A 2^{nd} Embodiment

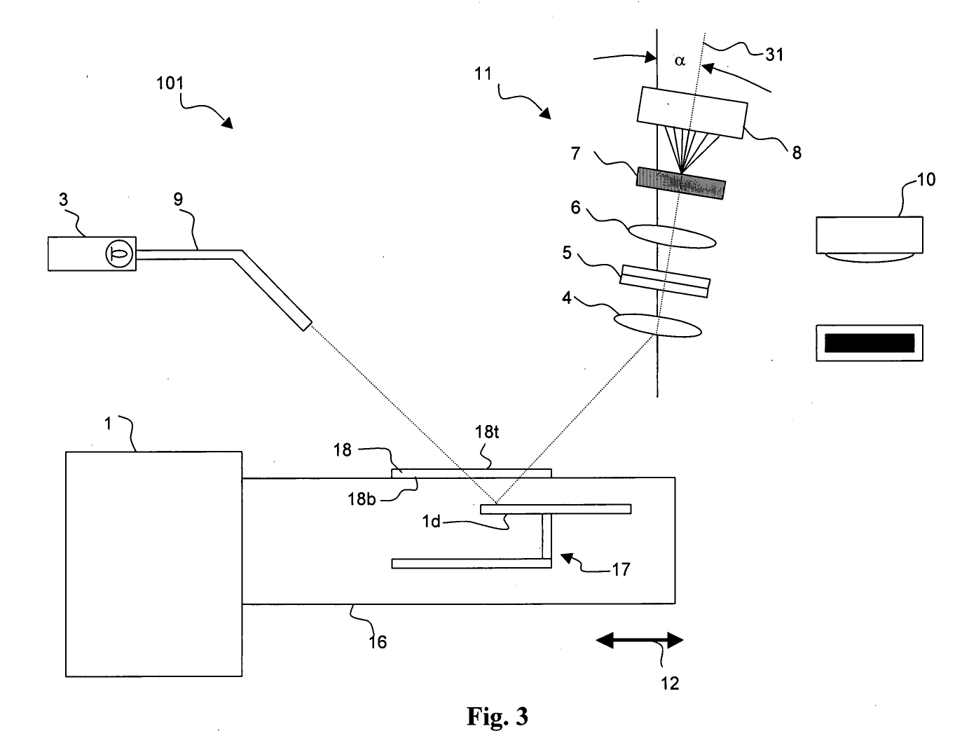

A second embodiment of the subject invention, suitable for measuring transparent or semi-transparent films, such as dielectrics deposited upon patterned semiconductor wafers, is illustrated in FIG. 3 and designated as an imaging system 101 in which, compared to FIG. 1 and FIG. 2, like elements are referenced with like identifying numerals. This embodiment is similar to the previous embodiments, with the exception that the wafer 1d is in a vacuum process or transfer chamber 16, and the wafer motion required for scanning is provided by a transfer robotics assembly 17 that is used to move the wafer inside vacuum chamber 16. Vacuum chamber 16 may be used for processing wafers or for transferring wafers. Transfer robotics assembly 17 allows wafer 1d to move in the X direction (indicated by numeral 12) relative to light source 3 and spectrometer 11. Visual access to wafer 1d is provided by a viewport 18. More specifically, light from light source 3 is directed to impinge upon wafer 1d via fiber bundle 9 through viewport 18. In addition, light reflected from wafer 1d is received by spectrometer 11 after passage through viewport 18. As transfer robotics assembly 17 moves wafer 1d through vacuum chamber 16 during normal CVD processing, spectral measurements are successively taken from successive portions of wafer 1d and provided to computer 10. Transfer robotics assembly 17 further serves to orient wafer 1d so that patterned features such as arrays of conductive lines are oriented to be co-planar with a plane defined by the wafer normal and the optical axis of spectrometer 11, which consequently enhances the precision with which film thickness measurements can be made. The plurality of spectral reflectance images of the patterned semiconductor wafer or portions of the wafer comprises a spectral image. Computer 10 may successively perform calculations on the data as it is received or it may do so after all or a substantial portion of wafer 1d has been scanned. As with the previous embodiments, computer 10 may use this data to estimate film thickness.

In addition to the advantages listed for the first embodiment, this embodiment has the additional advantage of providing rapid in-line film thickness measurements taken during the normal transfer motion of the wafers between processes. This means that measurements can be made without slowing down the process and thus will not negatively affect throughput. Also, because the unit is compact and can be integrated into existing equipment, very little additional cleanroom space is required. Additionally, because there are no added moving parts, the system is very reliable. Moreover, because this embodiment is disposed entirely outside of vacuum chamber 16, it introduces no particles or contamination to the fabrication process.

Although the foregoing embodiment is described in the context of CVD processing of semiconductor wafers, and is illustrated in combination with a CVD station for performing this function, skilled artisans will appreciated that these embodiments may be applied in other contexts and in combination with other processing apparatus. In fact, any application or industrial process in which in-line film measurement is desired, i.e., film measurement performed during an ongoing industrial process, may exploit the benefits of the present invention.

Method of Forming a Line Image

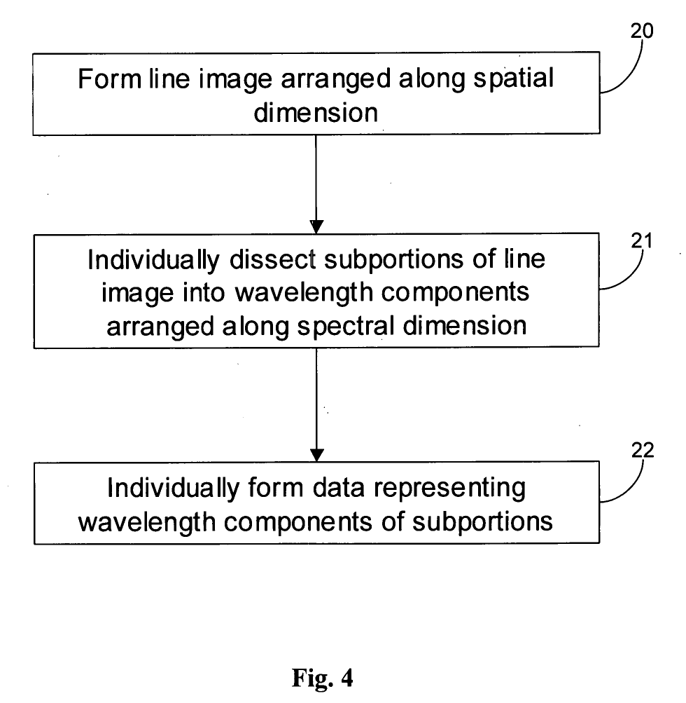

An embodiment of a method according to the invention is illustrated in FIG. 4. As illustrated, in step 20, a line image of a corresponding line of a film is formed. The line image has subportions arranged along a spatial dimension. Step 20 is followed by step 21, in which subportions of the line image are individually dissected to their relevant constituent wavelength components. The wavelength components for a subportion are arranged along a spectral dimension. Step 21 is followed by step 22, in which data representative of the wavelength components of the subportions is individually formed. The process may then be repeated for successive lines of the film until all or a selected portion of the film has been scanned. Throughout or at the conclusion of this process, estimates of film thickness or other film properties may be formed from the assembled data.

### Other Embodiments

In an example embodiment of the subject invention, suitable for use in a CVD environment, light source 3 comprises a tungsten/halogen regulated light source, manufactured by Stocker & Yale, Inc. of Salem, N.H. Fiber or fiber bundle 9 in this embodiment is a bundle configured into a line of fibers to provide uniform illumination along the measured surface. Several companies, Stocker & Yale being a prime example, currently manufacture such a fiber optic “line light”. This example is further configured for use with CVD processing system Model P5000 manufactured by Applied Materials Inc. of Santa Clara, Calif. An optically clear viewport 18 is provided in the standard P5000 configuration.

Line imaging spectrometer 11 in this example is manufactured by Filmetrics, Inc., San Diego, Calif., the assignee of the subject application. In this spectrometer, imager 8 is a CCD imager incorporating a time delay and integration line scan camera manufactured by Dalsa Inc., Part No. CT-E4-2048 that has a CCD imager with 2048 pixels in the system spatial direction and 96 pixels in the system spectral direction. Optometrics of Ayer, Mass. manufactures transmission diffraction grating 7 as Part No. 34-1211. The lenses 4 and 6 are standard lenses designed for use with 35 mm-format cameras. The line scan camera is custom-configured to operate in area-scan mode, with only the first 32 rows of pixels read out. This results in a data read rate greater than 1000 frames per second. Thirty-two rows of spectral data are sufficient for measurement of thicknesses in the range required for CVD deposited layers.

It has been found that this example embodiment yields a thickness accuracy of ±1 nm at a 1000 nm film thickness, at a rate of five seconds per wafer scan.

### Commercial Embodiment

A commercial embodiment of a system according to the invention will now be described. The manufacturers of the components of this system are as identified in the previous example, with the exception of the lens assembly used in the spectrometer. In lieu of standard lenses designed for use with 35 mm cameras, this embodiment employs high quality lenses and mirrors manufactured by Optics 1 of Thousand Oaks, Calif. These lenses and mirrors are such that the modulation transfer function (MTF) for a plurality of alternating black and white line pairs having a density of about 40 line pairs/nun is greater than 70% over the entire wavelength range of interest.

This system is configured to measure the thicknesses of individual layers of a sample, e.g., a patterned semiconductor wafer, at desired measurement locations. The coordinates of these desired measurement locations are provided to the system. Rather than rely on complicated and unreliable traditional pattern recognition techniques to find the exact measurement locations, the thickness of the wafer at each of these desired locations is determined by comparing the actual reflectance spectra for locations in a larger area containing the desired measurement location with a modeled reflectance spectra for the area assuming a particular layer thickness. If the comparison is within a desired tolerance, the assumed thickness is taken to be the actual thickness. If the comparison is not within the desired tolerance, the assumed thickness is varied, and the modeled reflectance spectra re-determined consistent with the newly assumed thickness. This process is continued until a comparison is performed which is within the desired tolerance. This process is repeated for a predetermined number, e.g. 5, of desired measurement locations on a layer of the wafer.

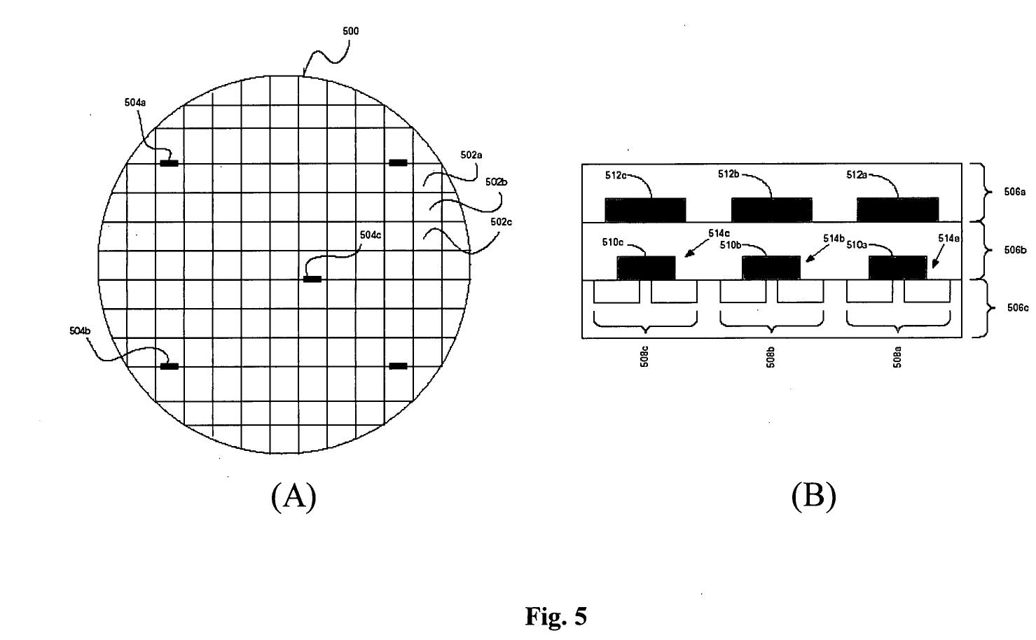

The situation can be further explained with reference to FIGS. 5A and 5B, which illustrate different views of an example 500 of a patterned semiconductor wafer. FIG. 5A illustrates a top view of wafer 500. As shown, wafer 500 may be divided up into individual dies 502a, 502b, and 502c. A plurality of predetermined measurement locations 504a, 504b, and 504c may also be provided. These measurement locations are typically situated in areas on the surface of wafer 500 that are between adjacent dies. The reason is that these areas tend to have areas designed for use as measurement locations. This can be seen from an examination of FIG. 5B, which illustrates an example of a cross-section of one of the dies of FIG. 5A. As illustrated, in this example, the cross-section has three layers, identified from top to bottom respectively with identifying numerals 506a, 506b, and 506c. A combination of features provided in layers 506b and 506c form field-effect transistors 514a, 514b, and 514c. Layer 506c in this example provides doped regions 508a, 508b, 508c within a silicon substrate, where the doped regions 508a, 508b, 508c serve as the source/drain regions, respectively, of transistors 514a, 514b, and 514c. Layer 506b in this example comprises regions 510a, 510b, 510c which serve at the gates, respectively, of transistors 514a, 514b, and 514c. The topmost layer 506a provides metal contact regions 512a, 512b, 512c, which may be selectively connected to individual ones of gate regions 510a, 510b, 510c during the processing of the die.

This cross-section is built up layer by layer in the following order: 506c, 506b, and 506a. During or after the process of adding each of the layers, 506a, 506b, 506c, it may be desirable to measure the thickness of the layer at one or more points. However, it will be seen that each of the layers includes features that make it difficult to precisely model the reflectance spectra at those locations. For example, layer 506c has source/drain regions 508a, 508b, and 508c; layer 506b has gate regions 510a, 510b, 510c; and layer 506a has contact regions 512a, 512b, and 512c. These features compound the problem of modeling the reflectance spectra at these areas within the die. To simplify the modeling process, then, predetermined measurement locations are determined in areas where there are typically fewer features present, thereby simplifying the modeling process. In FIG. 5A, examples of these locations are the locations identified with numerals 504a, 504b, and 504c. Most often, open areas approximately 100 μm×100 μm are included in the wafer pattern design to serve as locations for film property measurements.

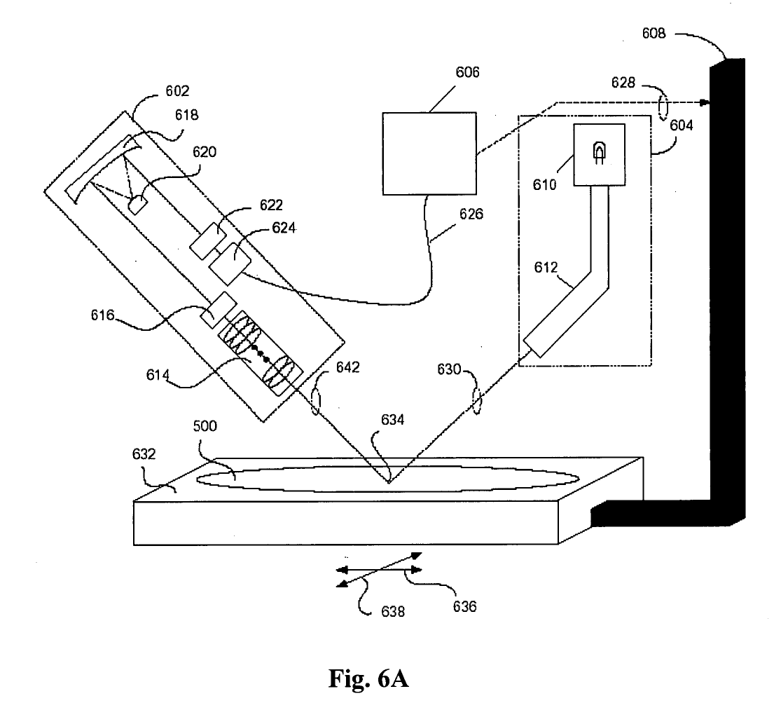

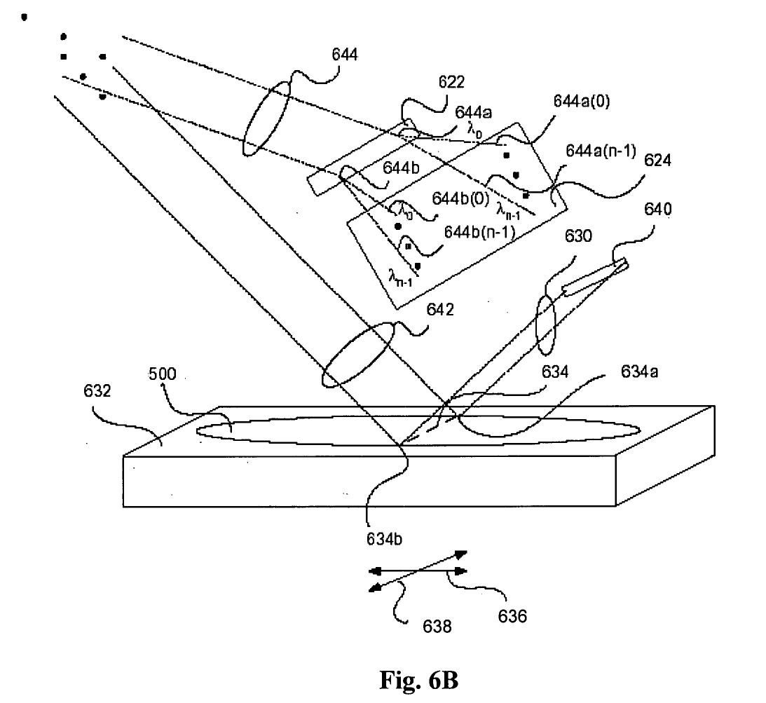

FIG. 6A illustrates an overall view of the commercial embodiment 600 of the present invention. A wafer 500 is supported on platform 632. A light source 604 directs light 630 to a plurality of locations 634 on the surface of wafer 500. In this embodiment, locations 634 form a line that spans the entire diameter of wafer 500. It should be appreciated, however, that embodiments are possible where the plurality of locations 634 form an irregular or curved shape other than a line, or form a line which spans less than the full diameter of wafer 500.

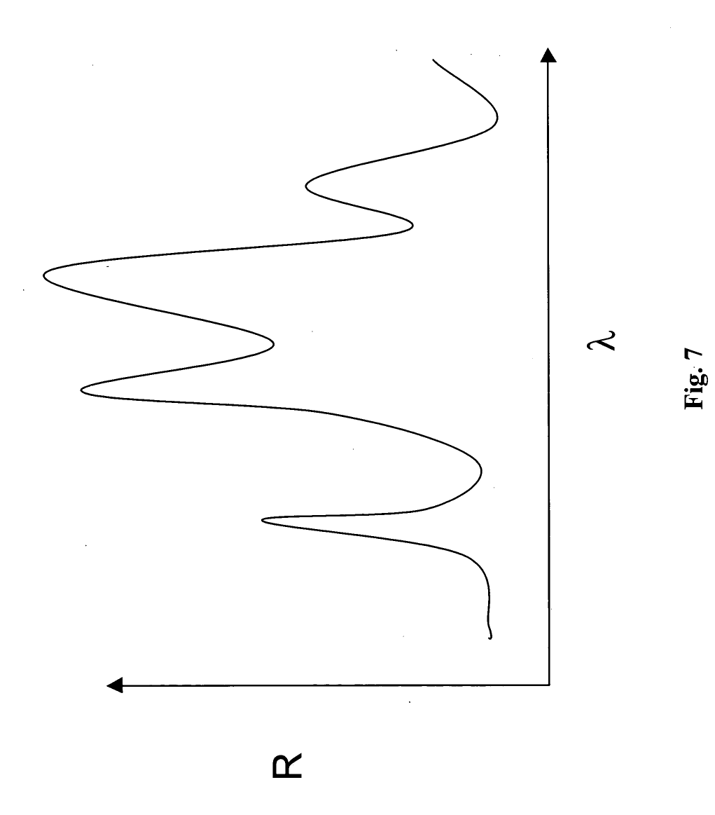

A sensor 602 receives light 642 reflected from the one or more locations 634, and determines therefrom the reflectance spectra representative of each of the one or more locations. The reflectance spectrum for a particular location on wafer 500 is the spectrum of the intensity of light reflected from that location as a function of wavelength, or some other wavelength-related parameter such as 1/λ, n/λ, nd/λ, or nd (cos α)/λ, where n is the index of refraction for the material making up the layer, λ is the wavelength, d is the thickness of the layer and oa is the angle that the optical axis of sensor 602 makes with respect to the wafer normal. An example of a reflectance spectrum for a location on the surface of wafer 500 is illustrated in FIG. 7.

Once determined, the reflectance spectra for plurality of locations 634 is provided to processor 606 over one or more signal lines 626, which may be implemented as a cable or other wired connection, or as a wireless connection or interface. This data may be provided to processor 606 concurrently with the capture of data from other locations on the surface of wafer 500. Alternatively, this transfer may be deferred until data for all or a substantial portion of the surface of wafer 500 has been captured.

Referring once again to FIG. 6A, a translation mechanism 608 is configured to relatively translate wafer 500 so that incident light 630 can be scanned across the entirety of the surface of wafer 500. Translation mechanism 608 may be under the control of processor 606 or some other control means. Translation mechanism 608 has the further capability of orienting wafer 500, under command of processor 606, so that the measurement plane is parallel with features such as any parallel conductive lines that may be present in wafer 500. In the current commercial embodiment, processor 606, as indicated by phantom line 628, provides control of translation mechanism 608. Also in the current commercial embodiment, where incident light 630 impinges on the surface of wafer 500 in the form of a line that spans the full diameter of wafer 500, wafer 500 need only be moved in the X direction (identified by numeral 636), but it should be appreciated that embodiments are possible in which other directions of scanning, or combinations of directions, are possible. For example, in the case where the incident light impinges on the surface of wafer 500 in the form of a line which spans half of the full diameter of the wafer, wafer 500 may be scanned in its entirety by scanning one half of the wafer in the X direction, then translating the wafer in the Y direction (identified by numeral 638) so that the remaining un-scanned portion of wafer 500 resides under the incident light, and then scanning the second half of wafer 500 by translating wafer 500 in the X direction.

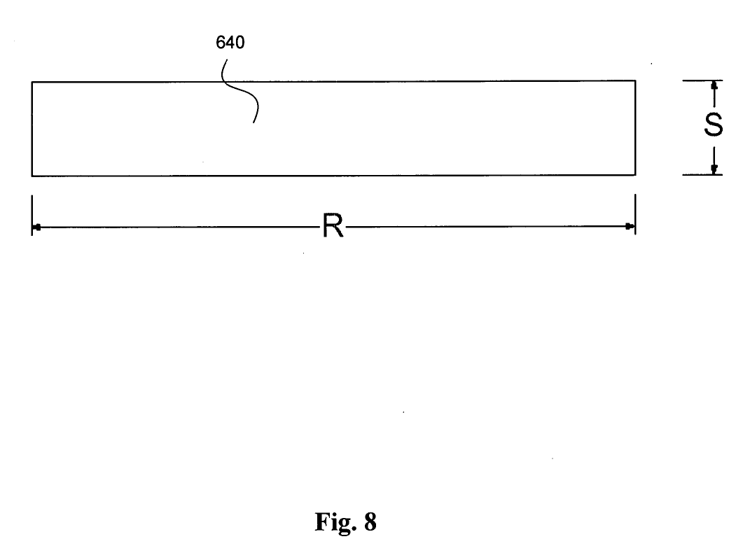

In the current commercial embodiment, where the plurality of locations 634 forms a line which spans the full diameter of wafer 500, light source 604 and sensor 602 are in a fixed relationship relative to one another, and translation mechanism 608 is configured to achieve relative translation between sensor 602 and wafer 500 by successively moving platform 632 in the X direction relative to light source 604 and sensor 602. However, it should be appreciated that embodiments are possible in which this relative motion may be achieved by moving light source 604 and/or sensor 602 relative to a stationary platform 632. In the present embodiment, light source 604 comprises a light generator 610 generating wavelength components over a desired wavelength range. In one aspect, light generator 610 may comprise a source of white light. In this commercial embodiment, light source 604 also includes a light shaper 612, which may be in the form of a fiber cable bundle. In one example, the individual fibers at the outer face 640 of the cable bundle form, in aggregate, a rectangular shape as shown in FIG. 6B and in FIG. 8. The rectangular shape of outer face 640 serves to project light from light generator 610 onto the surface of wafer 500 in the form of a line in the Y direction that spans the full diameter of wafer 500, which in this example is a 100 mm diameter. With reference to FIG. 8, the number of fibers currently employed in the long dimension, R, is about 10,000 fibers. The number of fibers currently employed in the short dimension, S, is about 10 fibers. Of course, it should be appreciated that other geometries and fiber configurations in face 640 are possible depending on the application. It should also be appreciated that embodiments are possible in which a light shaper 612 may be formed from components other than fiber cables.

Sensor 602 in the current commercial embodiment includes a lens assembly 614 situated along the optical path traced from the surface of wafer 500 by reflected light 642. Lens assembly 614 functions to reduce the length of reflected light 642 from about a 100 mm line to about a 26 mm line.

Slit 616, concave mirror 618, and convex mirror 620 are also included within sensor 602, and are also placed along the optical path traced by the reflected light 642. In the current commercial embodiment, these optical elements are placed after lens assembly 614 in the order shown in FIG. 6A. Slit 616 functions to aperture the light emerging from lens assembly 614 so that it is in the form of a line, and mirrors 618 and 620 function to direct the light so that it impinges upon transmission diffraction grating 622 that next appears along the optical path. As previously discussed, the entire lens/slit/mirror assembly is of sufficient quality that the MTF for an alternating black and white line pattern having a density of 40 line pairs/mm is not less than 70%.

It should be appreciated that lens assembly 614, slit 616, and mirrors 618 and 620 are not essential to the invention, and that embodiments are possible where these components are avoided entirely, or where other optical components are included to perform the same or similar functions.

In the current commercial embodiment, the light that impinges on diffraction grating 622 is located close to imager 624 and is thus close to being focused back into the form of a line. The situation is as depicted in FIG. 6B in which, relative to FIG. 6A, like elements are identified with like reference numerals. As illustrated, incident light 630 from outer face 640 of light shaper 612 is in the form of a line, and impinges upon wafer 500 in the form of a line 634 that spans the full diameter of wafer 500 in the Y direction 638. The reflected light 642 is also in the shape of a line, and after various resizing and shaping steps, impinges upon diffraction grating 622. Impinging line 644 is divisible into portions, each of which is representative of corresponding portions of wafer 500 along line 634. For example, portion 644a of light 644 impinging on diffraction grating 622 is representative of portion 634a of wafer 500, and portion 644b of light 644 impinging on diffraction grating 500 is representative of portion 634b of wafer 500.

Diffraction grating 622 breaks each of the individual portions of line 644 into their constituent wavelengths. Thus, with reference to FIG. 6B, grating 622 breaks portion 644a into n wavelength components, λ₀, . . . , λₙ₋₁, identified respectively with numerals 644a(0), . . . , 644a(n−1), and also breaks portions 644b into n wavelength components λ₀, . . . , λₙ₋₁, identified respectively with numerals 644b(0), . . . , 644b(n−1).

The wavelength components from each of the portions of line 644 impinge on imager 624, which measures the intensity of each of these wavelength components. Imager 624 then provides data representative of each of these intensities to processor 606 via signal lines 626.

In the current commercial embodiment, imager 624 has a resolution of 2048 pixels by 96 pixels, although only 32 pixels in the vertical (spectral) dimension are used. In the spatial dimension, sensor 602 images about 100 mm of wafer 500 onto the 2048 pixels of imager 624, which corresponds to approximately 50 μm of the wafer surface being imaged onto each pixel. The width of slit 616 in the spectral dimension determines the measurement spot size in the direction perpendicular to the line image, and is chosen so that the spot size is 50 μm in this dimension as well. This makes the resulting measurement spot size approximately 50 μm×50 μm square over the entire 100 mm line being measured on the wafer. Additional commercial embodiments, such as the Filmetrics STMapper, measure larger wafers with the same sensors by simply mounting multiple sensors side-by-side to measure contiguous 100-mm-wide swathes of the wafers simultaneously. For example, the very common 200 mm diameter wafers are measured by mounting two sensors side-by-side, and the larger 300 mm diameter wafers are measured by mounting three sensors side-by-side.

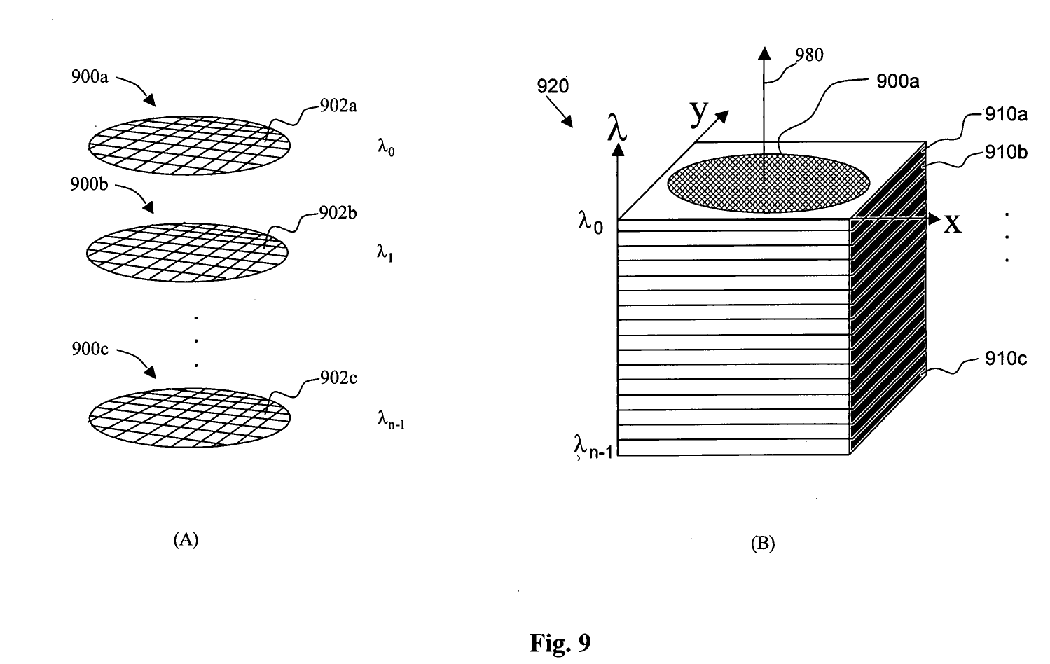

Once the scanning of a layer has been completed, processor 606 has access to the reflectance spectra for all or a substantial portion of the entire surface of wafer 500. This data can be depicted as shown in FIG. 9A. Numeral 900a identifies the reflectance data for points on wafer 500 for the first wavelength component, λ₀; numeral 900b identifies the reflectance data for the second wavelength component, λ₁, and numeral 900c identifies the reflectance data for the (n−1)th wavelength component, λₙ₋₁. Referring to FIG. 9B, reflectance data 900a in combination with off-wafer data points for the first wavelength component), comprises reflection data 910a. Reflectance data 900b in combination with off-wafer data points for the second wavelength component λ₁ comprises reflection data 910b. Likewise, reflectance data 900c in combination with off-wafer data points for the first wavelength component λₙ₋₁ comprises reflection data 910c. The ensemble of reflectance data 910a through 910c comprises a spectral image 920, shown in FIG. 9B.

In the current commercial embodiment, there are 32 wavelength components provided for each pixel location. The collection of these wavelength components constitutes the reflectance spectrum for the pixel location. Thus, with reference to FIG. 9A, the wavelength components identified with numerals 902a, 902b, and 902c collectively constitute the reflectance spectrum for a site on the surface of wafer 500. Currently, about 1 Gbyte of data is generated for each layer, so the processor must include a storage device that is capable of storing this quantity of data.

Once the data for a layer has been captured, processor 606 analyzes the data and determines therefrom the thickness of the layer at one or more desired measurement locations. In the current commercial embodiment, the coordinates of these measurement locations are known, and accessible to processor 606. Processor 606 also has access to information that describes the structure of the wafer at the desired measurement locations sufficiently to allow the reflectance spectra at the desired locations, or the immediately surrounding areas, to be accurately modeled. Such information might include the composition of the layer in question and that of any layers below the layer in question, a description of any features, such as metal leads and the like that are present in the layer in question and in any layers below the layer in question, and the thicknesses of any layers below the layer in question. For each of the desired measurement locations, processor 606 is configured to use this information to model the reflectance spectrum of that location, or surrounding areas, assuming a thickness for the layer in question.

Processor 606 is further configured to compare the modeled reflectance spectra of a desired measurement location, or surrounding locations, with the actual reflectance spectra acquired from these locations, and if the modeled spectra is within a defined tolerance of the actual spectra, determine that the assumed layer thickness is the actual layer thickness. If the comparison is not within the defined tolerance for the measurement location in question, processor 606 is configured to vary the assumed layer thickness, remodel the modeled reflectance spectra according to the assumed layer thickness, and then re-perform the comparison until the modeled data is within the prescribed tolerance. Processor 606 is further configured to repeat this process for each of the desired measurement locations on a layer.

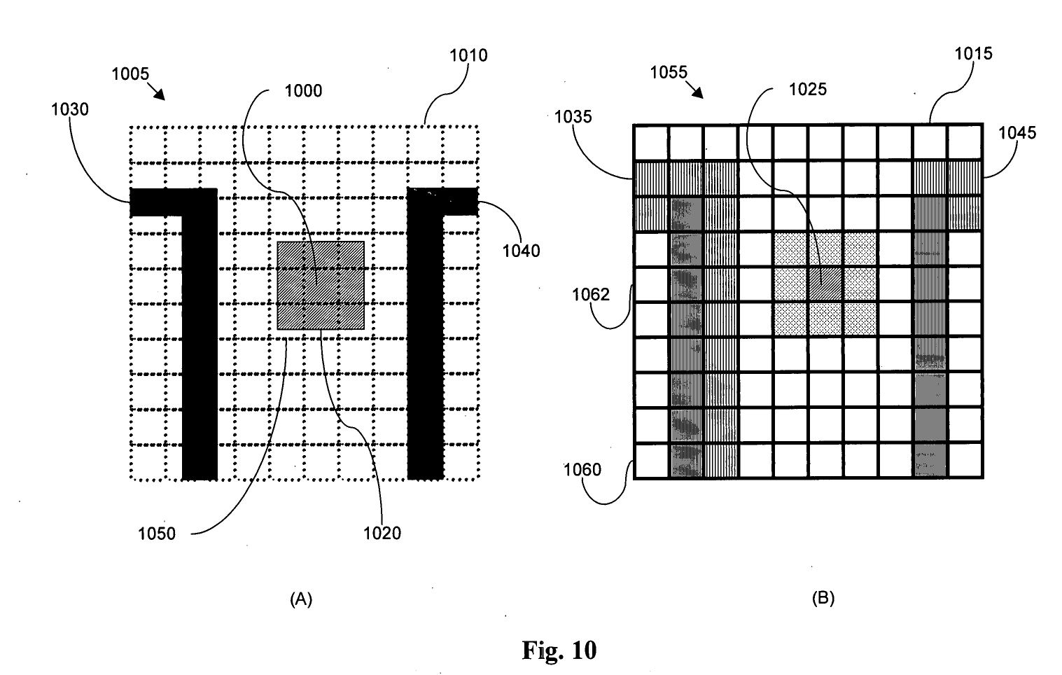

In the current commercial embodiment, processor 606 performs the comparison over a 10×10 pixel area centered on the nominal position of the desired measurement location. Analysis of more than one pixel is generally required because there is some uncertainty in the exact location of the desired measurement spot relative to the acquired wafer image, due to image imperfections caused by wafer vibration or other non-idealities. The situation is illustrated in FIG. 10, which illustrates a 10×10 pixel area surrounding the nominal desired measurement location 1000.

As an example, FIG. 10(A) shows a portion 1005 of wafer 500 with the outline of pixels superimposed on portion 1005. In particular and as an example, FIG. 10(A) shows bond pad 1020 between die edge 1030 and die edge 1040. A desired measurement site 1000 lies in the center of bond pad 1020. Each pixel corresponds to a portion of wafer 500 from which the reflectance data 900 are taken, as depicted in FIG. 9. Some pixels, such as pixel 1010, align with a uniform film stack, whereas other pixels, such as pixel 1050, cover more than one film stack (a portion of bond pad 1020 and the street between die edge 1030 and die edge 1040 in this case).

FIG. 10(B) shows an image of portion 1055 with the outline of pixels visible. The fill of each pixel represents the spectrum associated with each pixel; like fill indicates like spectra. Because of the small scale, there is some blurring in image of portion 1055. However, features are clearly delineated, and more importantly, there is at least one pixel corresponding exclusively to a bond pod 1020, namely pixel 1025.

Processor 606 is configured to compare the modeled spectrum with the measured spectrum for each of these pixels, and to compute a running sum, Rsum, of the absolute value of the difference for each wavelength component for each of the spectra. Mathematically, this process can be represented as follows:

$$RSum = {\sum }_{i} ABS ( {Δ}_{i} ) \qquad ( 1 )$$

where the index i ranges over all possible wavelength components for a given pixel (currently 32), Δᵢ is the difference between the modeled and actual intensities of the i^{th} wavelength component for the pixel being analyzed, and ABS is the absolute value function. For pixels over non-uniform film stacks such as pixel 1050, convergence to any spectra is difficult, but for pixels over uniform film stacks such as pixel 1010, convergence can be very rapid provided the comparison is done to the appropriate model spectra. In the case of pixel 1020, which is well aligned with bond pad 1020 and includes the nominal desired measurement location 1000, convergence to the model spectra is very rapid.

However, it should be appreciated that other methods of performing the comparison are possible and within the scope of the invention, such as methods in which less or more than a 10×10 area is involved, in which the comparison is performed over an area that is not necessarily centered on a desired measurement location, and in which functions other than the ABS function are employed. For example, in one alternative, the following statistic may be employed:

$$RSum = \sqrt{{\sum }_{i} {Δ}_{i}^{2}} \qquad ( 2 )$$

It is very useful to be able to automatically identify the locations of specific features such as bond pad images. With continuing reference to FIG. 10(B), pixels corresponding to like spectra can be used to identify high contrast regions such as those found at the edge of die. By looking for spectral signatures, one can identify key features such as bond pads. For example, an examination of a row 1060 leads to the signature of two high contrast regions with five pixels having the signature of streets in between. Likewise, an examination of a row 1062 leads to the signature of two high contrast regions with the signature of two pixels corresponding to streets sandwiched around three pixels corresponding to either bond pad material or a mixture of bond pad material and street material. In a similar fashion other structures can be identified.

### Method of Operation—Commercial Embodiment

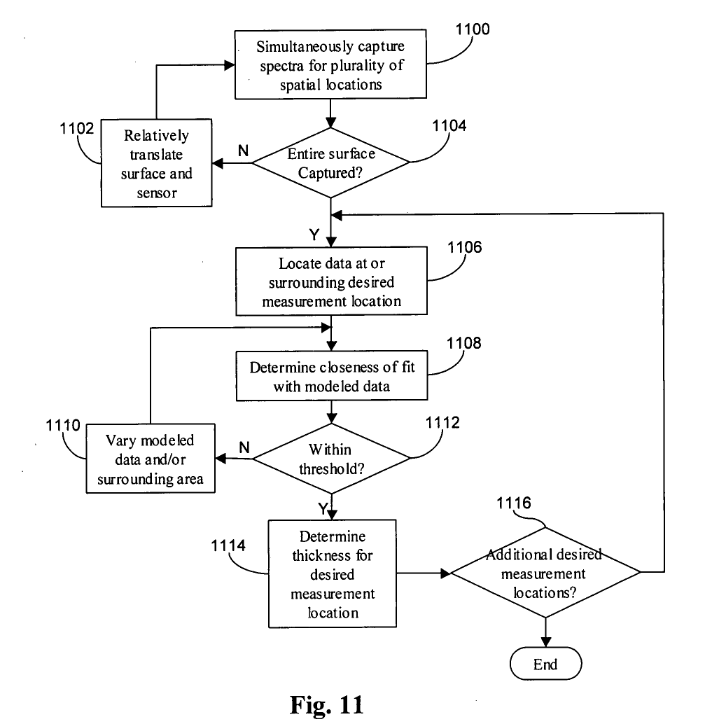

FIG. 11 is a flowchart of the method of operation followed by the current commercial embodiment for each layer in the sample being evaluated. The sample may be a semiconductor wafer or some other sample. In step 1100, the reflectance spectra for a plurality of spatial locations on the surface of a sample are simultaneously captured. The spatial locations may be in the form of a line, or some other shape, such as a curved shape, although in the current commercial embodiment, the locations are in the form of a line.

In step 1004, an evaluation is made whether all or a substantial portion of the entire surface has been scanned. If not, step 1102 is performed. In step 1102, a relative translation is performed between the surface of the sample and the light source and sensor used to perform the capture process. Again, this step can occur by moving the surface relative to one or the other of the light source and sensor, or vice-versa. Step 1100 is then re-performed, and steps 1100 and 1102 repeated until all or a desired substantial portion of the entire surface of the layer has been scanned.

When all or a desired substantial portion of the entire surface of the layer has been scanned, step 1106 is performed. In step 1106, the coordinates of a desired measurement location are used to locate the reflectance data for that location or a location within a surrounding area. Step 1108 is then performed. In step 1108, the reflectance data for the location or a location within the surrounding area is compared with modeled reflectance data for that location to determine if the modeled data and actual data are within a prescribed tolerance. This modeled data is determined assuming a thickness for that layer at or near the desired measurement location.

The closeness of the fit is evaluated in step 1112. If the fit is outside a prescribed tolerance, step 1110 is performed. In step 1110, the reflectance data for the location is re-modeled assuming a different layer thickness and/or the location from which the actual data is taken is varied. Steps 1108 and 1110 are then re-performed until the modeled data is within the prescribed tolerance of the actual data. When this occurs, step 1114 is performed. In step 1114, the assumed layer thickness for the modeled data that satisfied the tolerance criteria in step 1112 is taken to be the actual layer thickness at the desired location.

Step 1116 is then performed. In step 1116, it is determined whether there are additional desired measurement locations for the layer in question. If so, a jump is made back to step 1106, and the process then repeats from that point on for the next location. If not, the process ends.

A variation on the method shown in the flowchart in FIG. 11 comprises inserting a step prior to step 1100 that includes a rapid scan of all or part of the sample, and an analysis to assess whether the sensitivity of the detector has been set properly. This analysis involves comparing the intensity recorded by each pixel to the maximum possible, and if the maximum of such intensity is within a pre-determined range that optimizes the measurements, then the logic of the method proceeds to step 1100; otherwise the sensitivity is adjusted to ensure that maximum intensity measurements obtained in step 1100 do fall within the pre-determined range at which point the logic of the method proceeds to step 1100.

Ellipsometric Measurements

With relatively minor modifications, the apparatus of the present invention can be used to form wide-area high-speed, high-resolution ellipsometric images.

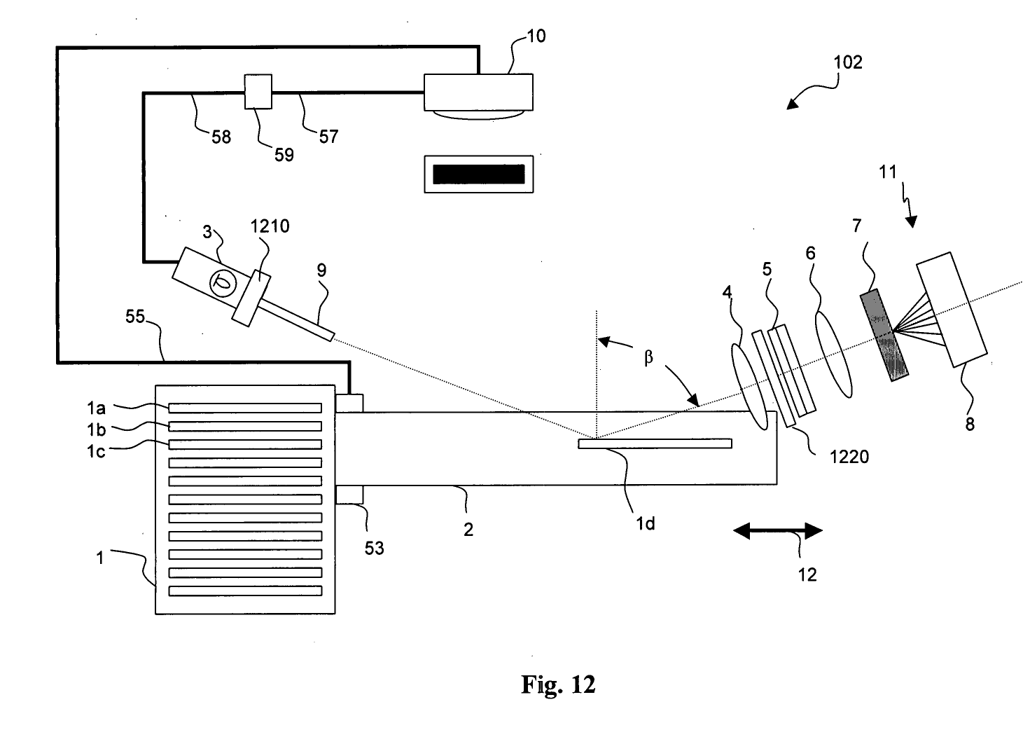

FIG. 12 shows system 102, which is identical to system 100 except for the addition of a polarizer 1210, a rotating analyzer 1220, and software in computer 10 to control rotating polarizer 1220 and to analyze the data obtained with system 102. Polarizer 1210 is a linear polarizer having a polarization axis that defines the polarization angle of maximum transmission. Polarizer 1210 is disposed between light source 3 and optical fiber 9 and serves to ensure that light emitted from light source 3 impinges upon wafer 1d linearly polarized. Likewise, rotating analyzer 1220 has a polarization axis that defines the polarization angle of maximum transmission. Rotating analyzer 1220 further includes a rotation mechanism controllable by computer 10 such that the polarization angle of rotating analyzer 1220 is known.

System 102 operates to collect light reflected from wafer 1d identically to system 100 except for the effects of using polarized light and the algorithms used to infer film characteristics such as film thickness. Light impinging upon wafer 1d is polarized due to polarizer 1210 and the light reflecting from wafer 1d undergoes polarization shifts according the film properties on wafer 1d. Rotating analyzer 1220 transmits light reflected from wafer 1d in accordance with the polarization axis of rotating analyzer 1220. The light continues to propagate through line imaging spectrometer 11 to two-dimensional imager 8 where it forms a polarized line image. Because analyzer 1220 rotates, it alternately passes s-polarized and p-polarized light. By sequentially capturing s-polarized and p-polarized light, spatial maps of Ψ and Δ can be generated from which, using well known methods, film properties such as thickness can be determined for each point and thus for all or portions of wafer 1d.

It is also important that data acquisition from two-dimensional imager 8 be synchronized with the velocity of wafer 1d so that alternating frames of data corresponding to s- and p-polarized light can be aligned so that rows of s- and p-polarized data overlap. Previously discussed light strobing and/or wafer tracking methods can be used. Ellipsometric measurements can also be made using alternate configurations. If polarizer 1210 and analyzer 1220 are replaced with a rotating polarizer and a fixed analyzer respectively, then a rotating polarizer configuration is obtained. The operation of such a configuration is basically the same except that the polarization of the incident light is modulated before reflecting from the surface of wafer 1d, and before being analyzed by the fixed analyzer and recorded by two-dimensional imager 8.

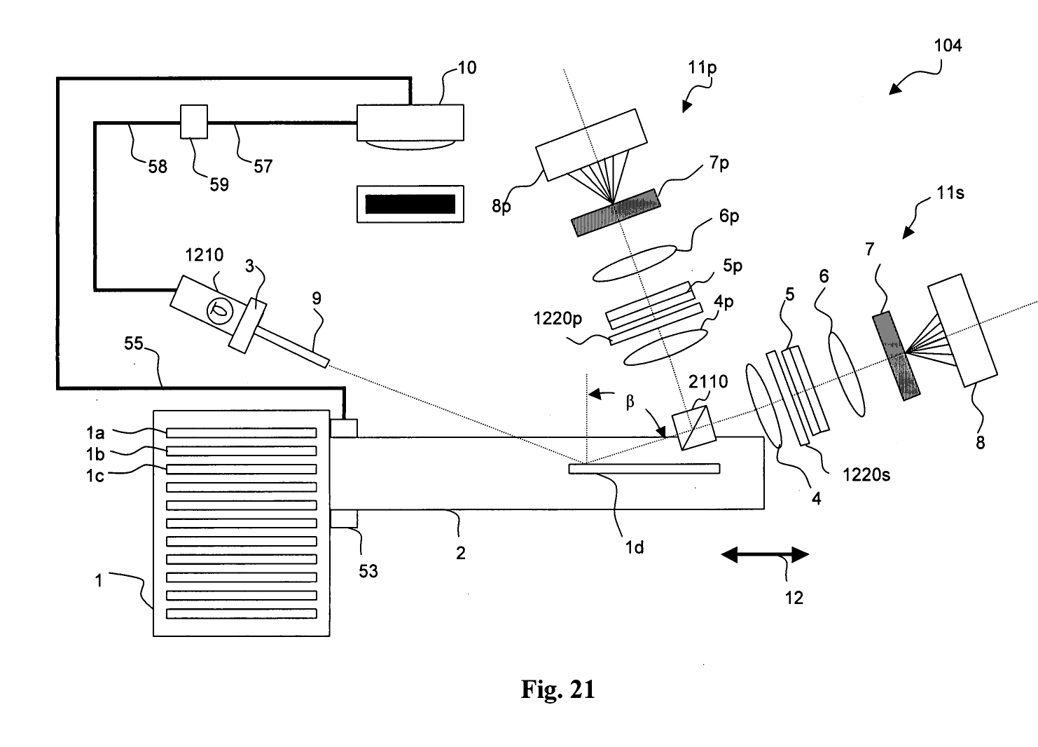

The foregoing embodiment is described such that s- and p-polarized light is sensed in sequentially alternating frames. To avoid the need to carefully synchronize the timing of frame grabbing to ensure that sequential images of s- and p-polarized images overlap, a dual sensor arrangement can be used, as shown in FIG. 21 as imaging system 104. In this embodiment, light reflected from wafer 1d passes through a non-polarizing beamsplitter 2110 before being analyzed and detected.

Beamsplitter 2110 is disposed within system 104 so that light reflected by the beamsplitter remains in the plane defined by angle β. Light passing through the beamsplitter is analyzed by a line imaging spectrometer 11s for s-polarized light, where line imaging spectrometer 11s is identical to line imaging spectrometer 11 except that rotating analyzer 1220 is replaced by a fixed analyzer 1220s that is oriented to pass s-polarized light. Light reflected by beamsplitter 2110 is analyzed by a second line imaging spectrometer 11p for p-polarized light, where second line imaging spectrometer 11p is identical to line imaging spectrometer 11s except that it includes a fixed analyzer 1220p that is oriented to pass p-polarized light.

The other elements of second line imaging spectrometer 11p (enumerated in FIG. 21 with a suffix ‘p’) are duplicates of like identified elements of line imaging spectrometer 11s. With careful alignment, pulse synchronization, wafer tracking, and using software image reversal on images captured with second line imaging spectrometer 11p, images captured with the two line imaging spectrometers can be disposed within system 104 so that s-polarized and p-polarized measurements of the same locations on wafer 1d are substantially aligned.

Yet other ellipsometric measurement arrangements can also be accomplished using the basic structure of system 100 with suitable modifications. Such ellipsometric measurement arrangements are well known in the art and include a rotating compensator ellipsometer (which require a narrow spectrum light source for effective operation), a polarization modulation ellipsometer, and a null ellipsometer.

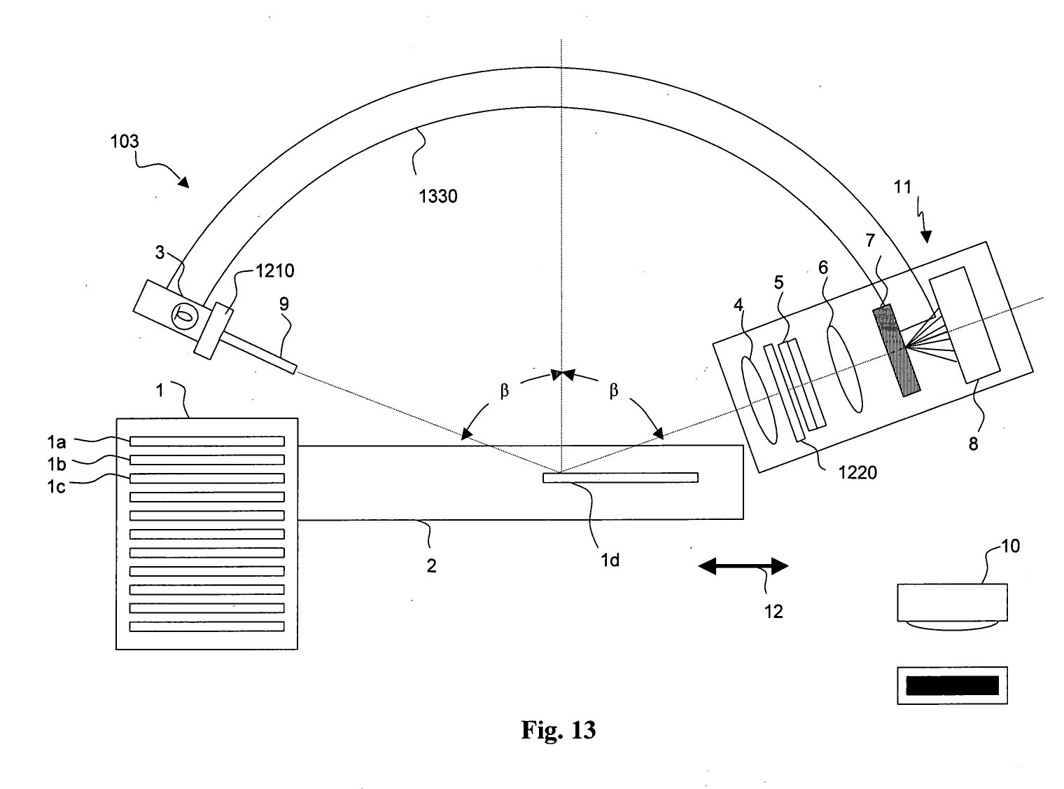

FIG. 13 shows a variable angle spectroscopic ellipsometer 103, which is yet another type of wide-area high-speed, high-resolution imaging ellipsometric imager that can be made according to the present invention. Ellipsometer 103 is identical to system 102 except for the addition of angle track 1330. Ellipsometer 103 functions in the same way as system 102 except that it allows Ψ and Δ to be measured over a range of angles β. Preferably, ellipsometric images are obtained at a fixed angle β, then β is adjusted to a different angle and another set of ellipsometric images are collected. This process continues over a range of angles that depends on the materials being measured. Since ellipsometric measurements are most sensitive when the incident light is incident at the Brewster angle, the ability to vary the angle β adds additional capability, especially when measuring complicated film structures where each layer may have a different Brewster angle (that is a function of the index of refraction), and a given multi-layer film stack may have a pseudo-Brewster angle. Since this apparatus allows measurements to be made over a wide range of angles, and since such measurements are made across the entire wafer 1d, wide-area high-speed, high-resolution images are obtained over a very wide area, with higher speed and with improved resolution than is possible with prior art techniques.

Erosion Measurements

The apparatus of the present invention can also be used to rapidly perform measurements to determine erosion, which occurs during CMP. Erosion is the excess removal of material in an array of metal lines or vias, and involves the removal of both metal and dielectric material though in unequal proportions. If too much metal is removed, then the integrated circuit so formed is subject to numerous performance issues ranging from degraded performance due to increased capacitance affecting RC time constants to joule-heating failures arising from excessive reduction of the cross sectional area of metal lines (Bret W. Adams, et al., “Full-Wafer Endpoint Detection Improves Process Control in Copper CMP”, Semiconductor Fabtech Vol. 12, p. 283, 2000). Other process defects such as shorting can also occur in subsequent process steps. Direct measurements of metal thickness values are not possible using spectral reflectance data (unless the metal layer is less than a few hundred nanometers, which is normally not the case if fabrication processes are in or near specifications). However, by exploiting the high-spatial resolution spectral data of the present invention, erosion measurements can be obtained.

To obtain erosion measurements, the reflectance apparatus of the present invention is used to shine light onto an array of metal lines following a CMP step, where the incident light is in a plane parallel to the lines and perpendicular to the array of metal lines. Once such light is incident upon an array of metal lines, film thickness measurements of the top-most layer can be made at multiple locations on the image of wafer 1d adjacent to and including a desired measurement site. These thickness measurements are obtained from between metal lines or vias. These measurements also include a measurement of a substantially un-eroded region. From these film thickness measurements an erosion value is calculated. One way of calculating the erosion value is to calculate the difference between the thickness of the thickest top-most layer and the thickness of the thinnest top-most layer. The thickest top-most layer corresponds to the thickness of an un-eroded region, thus the difference corresponds to the amount of the top-most layer that has been eroded.

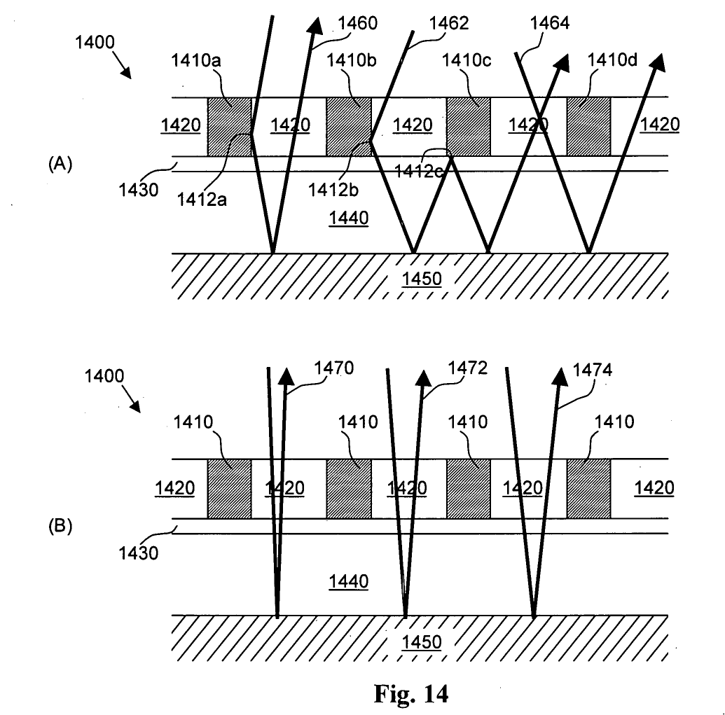

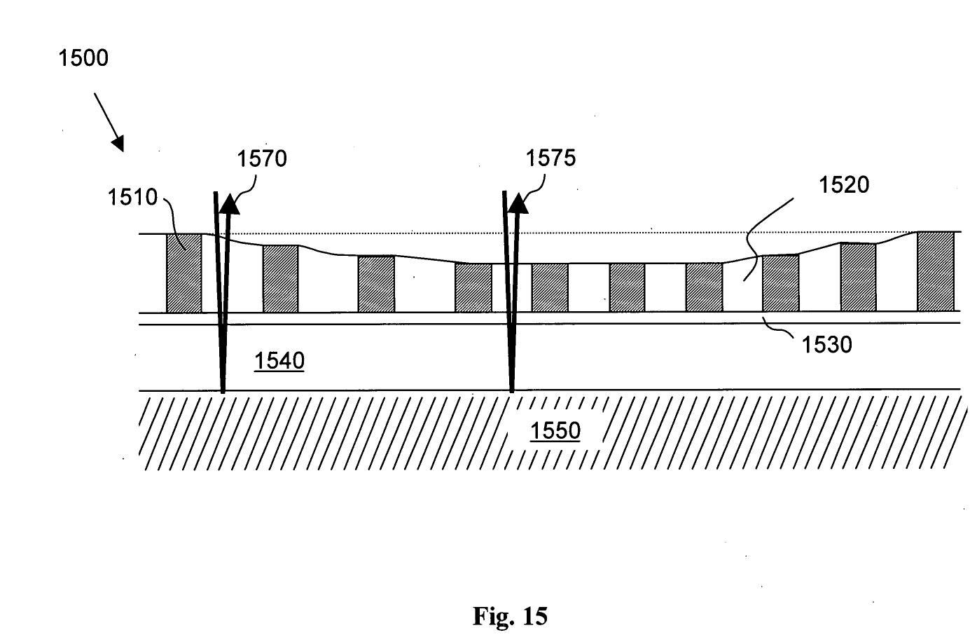

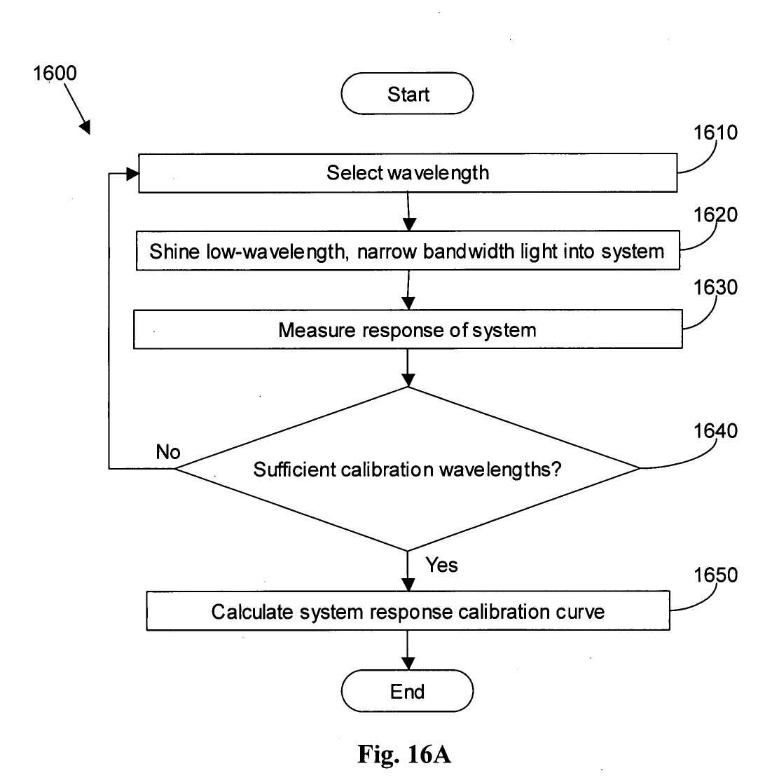

FIG. 14 shows an example patterned film structure 1400 that includes an array of copper lines 1410a-1410d surrounded by silicon dioxide 1420 over a thin layer of silicon nitride 1430, a second layer of silicon dioxide 1440, and a silicon substrate 1450. FIG. 14(A) shows incident light rays 1460, 1462, and 1464 striking patterned structure 1400 over a range of relatively large incident angles. Incident light rays 1460, 1462, and 1464 strike copper lines 1410a-1410c at sidewalls 1412a and 1412b and at underside 1412c, respectively. For simplicity no refractive or diffractive effects are included though they would normally be present. In particular, light ray 1460 strikes copper line 1410a at sidewall 1412a, and reflects off substrate 1450 before passing between copper line 1410a and 1410b and finally leaving patterned structure 1400. Light ray 1462 demonstrates different behavior in that after reflecting off sidewall 1412b of copper line 1410b and substrate 1450 it reflects off underside 1412c of copper line 1410c, which leads to a second reflection off substrate 1450 before exiting patterned structure 1400 as shown. In general, a multiplicity of reflections between copper lines 1410 and substrate 1450 is possible, each reflection of which introduces increased dependence of the reflectance spectrum upon the copper lines. Light ray 1464, which has a relatively large incident angle, undergoes a single reflection off substrate 1450 before exiting patterned structure 1400. Light rays 1460 and 1462 have optical path lengths that depend significantly upon parameters of the copper lines such as width, thickness, and sidewall angle. Consequently, the overall reflectance signal depends significantly upon these physical parameters. In general, the greater the angle of the incident light, the more the light interacts with and is sensitive to the copper line dimensions and shape.

In contrast, FIG. 14(B) shows that light with a small NA incident at small angles leads to a high percentage of light passing by copper lines 1410 with reduced deflections off sidewalls 1412, reflecting off substrate 1450, and passing again between copper lines 1410 with substantially reduced reflections off of sidewalls 1412. Thus, by using small NA light rays incident at a small angle, the extent of the variation of reflections due to variation of patterned features such as copper lines 1410 is minimized, which leads to significantly reduced sensitivity of the reflectance spectrum to variations in the copper line dimensions. This means that erosion can be measured with this simple system without undue sensitivity or interference from variations in metal line dimensions. The metal lines still have to be accounted for when modeling the wafer structure to determine the thickness of the top oxide layer using well-known methods such as Rigorous Coupled Wave Analysis (RCWA). Normally encountered variations in the metal dimensions are typically not enough to cause inaccuracies in oxide thickness determination. In contrast, high-NA measurement systems, such as those previously mentioned that use microscope objectives to acquire spectral reflectance from a single point, are much more sensitive to variations in metal line dimensions because of the effect such variations have on the overall reflectance.

The reflectance of light incident upon an array of lines such as copper lines 1410 depends in part upon the polarization of the incident light and the orientation of copper lines 1410. Copper lines 1410 thus behave like a wire grid polarizer, as described in U.S. Pat. No. 6,532,111. Thus the polarization of the light in apparatus 100 may be restricted to one polarization and this effect may be used advantageously in combination with the advantages of the low NA, low incident angle light in analyzing three-dimensional structures. If the incident light in system 102 is linearly polarized as a result of polarizer 1020 so that the light has an electric field nominally perpendicular to copper lines 1410, then the light passes easily into the patterned structure 1400 where it reflects and again passes easily out of patterned structure 1400. If the incident light has an electric field nominally parallel to copper lines 1410, then a greater portion of the light reflects from the patterned structure 1410 compared to the case of light with an electric field perpendicular to copper lines 1410. Arrays of conductive lines on a patterned semiconductor wafer are almost always parallel or perpendicular to a notch line extending from the wafer center to the notch.

In addition, each metallization layer generally has almost all lines oriented in the same direction. Thus, one can rotate wafer 1d using platform 2 so that the lines are perpendicular to the electric field of the polarized light and so that most of the light passes through the metal features. Ensuing measurements are therefore particularly sensitive to layers between and beneath the metal features. Likewise, platform 2 can be used to rotate wafer 1d so that the metal lines are parallel to the electric field of the polarized light so the ensuing measurements are more sensitive to light reflecting off of the top of the metal features. Such measurements are more sensitive to the layer above the metal features than to layers below the lines. In other cases where it is not possible to rotate the wafer or where horizontal and vertical lines are approximately equally abundant, it may be preferable to use randomly polarized light or circularly polarized light so that the reflectivity is substantially insensitive to the orientation of the wafer.

FIG. 15 shows an example of how the apparatus of the present invention is used to determine erosion. In particular, FIG. 15 shows a patterned structure 1500 that has been partially eroded. This structure includes an array of copper lines 1510, each copper line 1510 surrounded by silicon dioxide 1520. The copper lines 1510 lie on top of a layer of silicon nitride 1530, a second layer of silicon dioxide 1540, and a substrate 1550, as shown. A spectral image of patterned structure 1500 includes reflectance due to light rays 1570 and 1575. Light ray 1570 passes between copper lines 1510 where there has been minimal erosion. Light ray 1575 passes between copper lines 1510 where there has been substantial erosion. Thus, calculating an erosion value involves determining a first thickness of silicon dioxide 1520 from light ray 1570 and a second thickness value of silicon dioxide 1520 from light ray 1575, and computing a net difference between the first thickness value and the second thickness value. The value of the net difference is the erosion value.

Correcting Second Order Diffraction Effects

The apparatus of the present invention can be used to correct for spectral overlap errors that distort the signal detected and cause errors. Light incident upon a grating at a given angle of incidence α satisfies the grating equation, mλ=d(sin α+sin β), where m is an integer, β is the diffraction angle and d is the grating period. For a given grating, there exist values of m and λ that satisfy the grating equation and result in light diffracting into the same angle, e.g. m=1 and λ, m=2 and λ/2, m=3 and λ/3, etc. Thus, a detector positioned to receive first order light corresponding to m=1 and λ also receives second order light corresponding to m=2 and λ/2, as well as third order light corresponding to m=3 and λ/3, and so on. The number of orders that must be accounted for depends on the diffraction efficiency of diffraction grating 7 for each order, the range of wavelengths of light emitted by light source 3, and the range of wavelengths over which two-dimensional imager 8 is sensitive.

By way of example, if using a light source with a range of wavelengths extending from 400 nm to 1000 nm, diffraction grating 7 scatters second order light from light having a wavelength of 400 nm into the same angle as first order light having a wavelength of 800 nm. A pixel in two-dimensional imager 8 aligned to receive the 400 nm light also receives the 800 nm light. In a similar manner, light from wavelengths ranging from 400 nm to 500 nm is scattered onto pixels that receive light ranging from 800 nm to 1000 nm. For this particular configuration, no third order spectral overlap correction is needed, and the response of two-dimensional imager 8 is given by
I(λ)=I₁(λ)+I₂(λ/2)·C(λ) (3)
where I(λ) is the measured response at a given wavelength, I₁(λ) is the contribution due to first order diffracted light, and I₂(λ/2) is the contribution due to second order diffracted light from λ/2, and C(λ) is a correction factor.
Method for Compensating for 2^{nd} Order Overlap

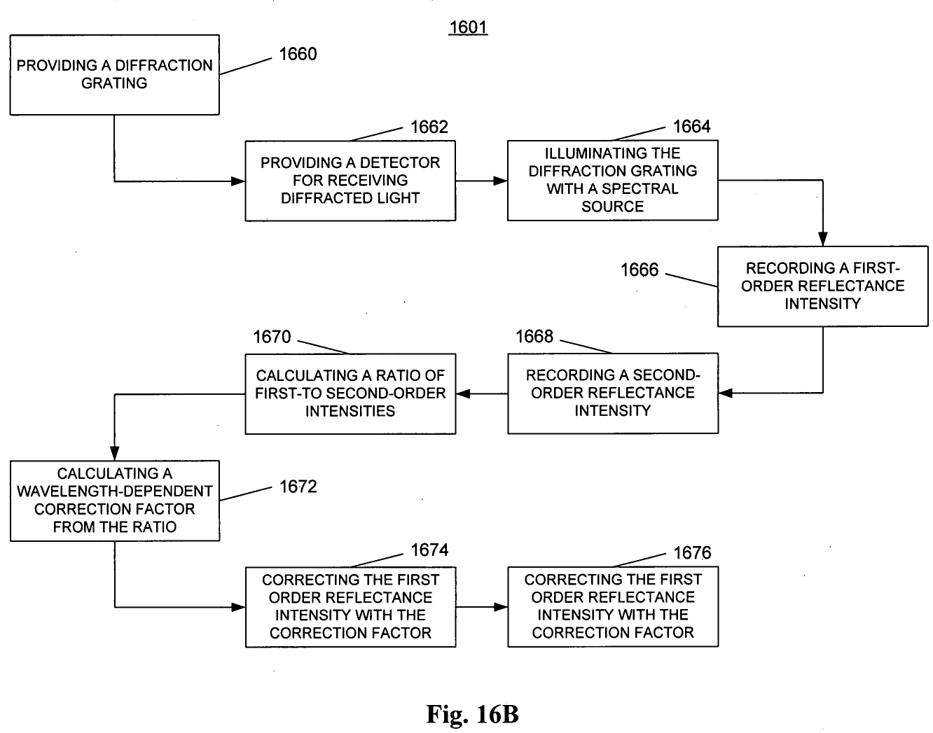

To account for spectral overlap of first and second order diffracted light in a system where orders higher than second are not present, method 1600 shown in FIG. 16A can be used. This method involves calibrating the response of two-dimensional imager 8 to second order diffracted light at several calibration wavelengths between the smallest wavelength of light that can be second order light and the upper limit of sensitivity of the detector. For example, if light source 3 has a minimum wavelength of 400 nm, and two-dimensional imager 8 has an upper limit of sensitivity of 1000 nm, then wavelengths in the range of 400 nm to 500 nm are selected.

Any of a variety of light sources can be used to provide narrow band calibration light including lasers and light emitting diodes. Furthermore, a relatively broadband source in combination with a narrow-band filter can also be used. However, light emitting diodes (LEDs) are preferred sources of light for this calibration procedure. Though lasers can also be used, they suffer the disadvantage of being of such narrow bandwidth that the exact location of light incident upon two-dimensional imager 8 is not known other than that it falls within the pixel that the light strikes. In contrast, LEDs normally have a bandwidth of 10 to 20 nm, which means that when such light strikes two-dimensional imager 8 it covers more than one pixel. By using well-known curve-fitting algorithms, the exact location of the peak can be found.

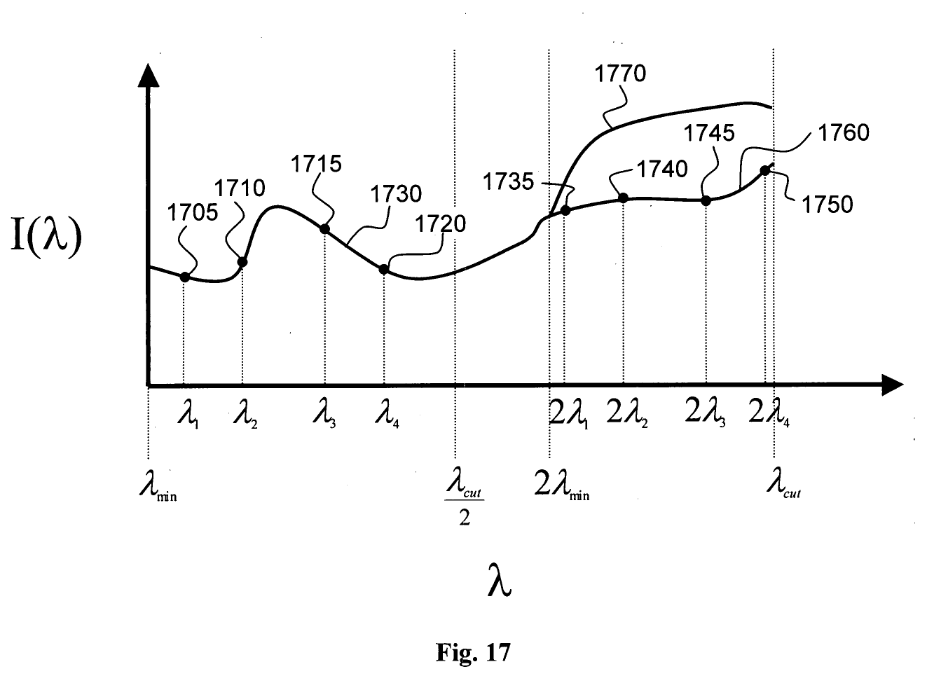

FIG. 17 shows the effect of an un-corrected spectral response curve and a corrected spectral response curve. Between 2λₘᵢₙ and λ_{cut} spectral overlap occurs that must be corrected for. A spectral response curve 1730 extends from λₘᵢₙ to 2λₘᵢₙ. In this wavelength range there is no spectral overlap. Above 2λₘᵢₙ is a spectral response curve 1770, which extends from 2λₘᵢₙ to λ_{cut} and includes both first and second order diffracted light. From equation (3) and from the figure, a portion of the light in this wavelength range must be subtracted from the total light detected to arrive at a corrected spectral curve. Equivalently, spectral response curve 1760 results from first order spectral light whereas spectral response curve 1770 results from first order spectral light augmented or distorted by second order light. Spectral response curve 1730, extending from λₘᵢₙ to 2λₘᵢₙ and spectral response curve 1760 extending from 2λₘᵢₙ to λ_{cut} constitute the corrected spectral response curve.

Step 1610 of method 1600 involves selecting a calibration wavelength to use. Since the contributions due to second order effects tend to vary relatively smoothly over the affected range, it suffices to use approximately four calibration wavelengths in the detector sensitivity range between λₘᵢₙ and λ_{cut}/2, that is, between the smallest detectable wavelength and half the maximum detectable wavelength. These wavelengths, designated as λ₁, λ₂, λ₃, and λ₄, are shown in FIG. 17. Using fewer than three wavelengths means that the correction is purely linear; using three wavelengths plus interpolation provides adequate correction. Using more than six wavelengths increases the accuracy of corrections, but at the expense of increased time.

Step 1620 of method 1600 involves directing the light into system 100 with light source 3 replaced by an LED emitting at a desired calibration wavelength. It should be noted that these calibration measurements could be performed with the angle α as small as zero degrees. Light at calibration wavelength λ I leads to first order intensity 1705 and second order intensity 1735 at 2λ₁. Likewise, light at calibration wavelength λ₂ leads to first order intensity 1710 and second order intensity 1740 at 2λ₂; light at calibration wavelength λ₃ leads to first order intensity 1715 and second order intensity 1745 at 2λ₃; and light at calibration wavelength λ₄ leads to first order intensity 1720 and second order intensity 1750 at 2λ₄.

Step 1630 of method 1600 involves sensing the light, including both first and second order wavelengths, and recording these measurements. By hypothesis, diffraction grating 7 generates first and second order diffracted light that strikes two-dimensional imager 8 at two locations on two-dimensional imager 8. This measurement results in a curve with two sharp peaks, a first peak corresponding first order diffracted light and a second peak corresponding to second order diffracted light. This curve is saved in memory.

Step 1640 of method 1600 assesses whether sufficient different wavelengths of light have been used. If measurements at sufficient wavelengths have been made, then the logic of method 1600 moves to step 1650; if not, then the logic of method 1600 moves to step 1610 and another wavelength is chosen.

Step 1650 of method 1600 calculates a system response based on measurements obtained in step 1630. For each intensity curve, i.e., for each calibration wavelength, the intensity values adjacent to a nominal peak that exceed a threshold value are selected. A peak-finding algorithm is used to determine precisely each peak amplitude and wavelength, one for first order diffracted light and one for second order diffracted light. Such peak-finding algorithms are well known; examples of such algorithms include parabolic fitting and Gaussian fitting. This peak-finding process is repeated for each calibration wavelength.

Having obtained precise peak amplitudes and wavelengths for each first and second order calibration wavelengths of light, a ratio of the peak amplitude corresponding to first order diffracted light to the peak amplitude corresponding to second order light is calculated, viz.,

$${R}_{i} ( {λ}_{i} ) = \frac{{I}_{2} ( \frac{{λ}_{i}}{2} )}{{I}_{1} ( {λ}_{i} )} . \qquad ( 4 )$$

where i ranges from 1 to the number of calibration wavelengths used, e.g. N (where N is typically 4).

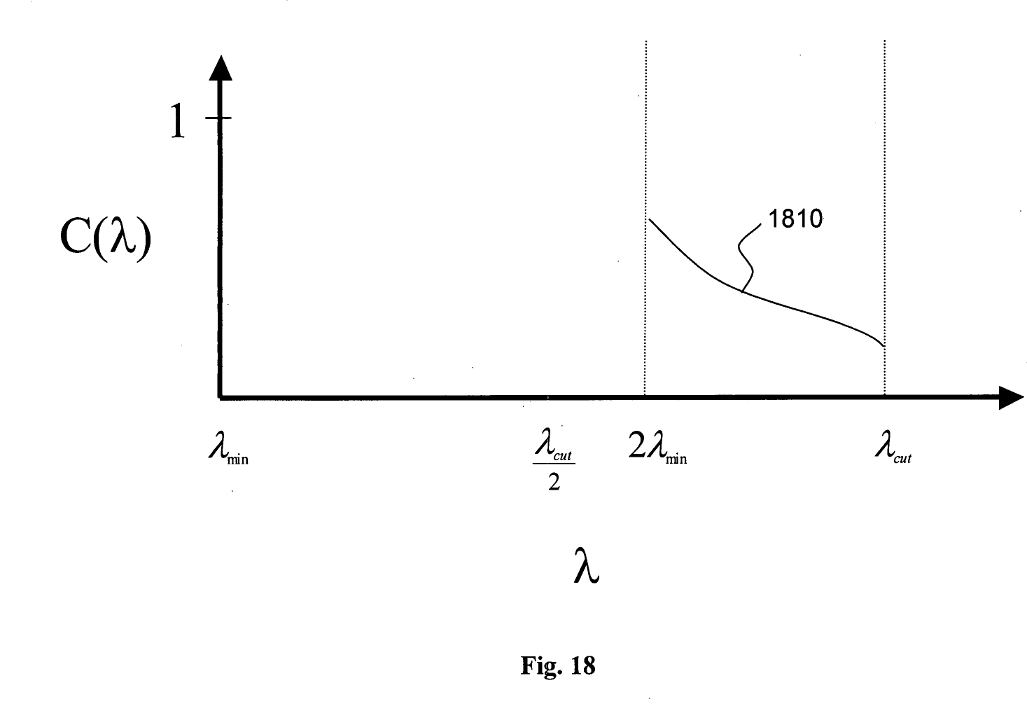

Step 1650 concludes by calculating the correction factor C(λ) by interpolating R₁(λᵢ) for wavelength values between λ₁ and λ_{N} and extrapolating for wavelength values between 2λₘᵢₙ and λ_{cut} that lie outside the range λ₁ and λ_{N}. The result is a piece-wise continuous correction factor 1810 shown in FIG. 18. Step 1650 concludes by storing the correction factor C(λ) in memory.

Another embodiment of a method 1601 according to the invention is shown in FIG. 16B. Method 1601 corrects for second order diffraction errors in reflectance spectra, such as spectra reflected from the surface of a wafer using any of the foregoing systems for analyzing properties of patterned thin films. The method begins at step 1660, in which a diffraction grating, such as diffraction grating 7, is provided for diffracting light. Next, step 1662 is performed, in which a detector is provided to receive the diffracted light. The detector is configured to have a minimum wavelength sensitivity and a maximum, or cutoff, wavelength. Step 1664 comprises illuminating the diffraction grating with a source of spectral illumination. In one example, the source comprises light reflected from the surface of a patterned wafer. In another example, the light may be focused by one or more lenses 4 or 6 as shown in FIG. 1.

The next step 1666 comprises recording at least one first-order reflectance intensity. In one embodiment, the reflectance intensity is recorded at the spectral source wavelength. In another embodiment, the wavelength emitted by the spectral source is between the minimum wavelength and one half of the cutoff wavelength. Similarly, in the next step 1668, at least one second-order reflectance intensity is recorded. The next step 1670 is a calculation step, in which a ratio of the first-order reflectance intensity to the second order reflectance intensity is calculated. For example, the ratio may be as modeled above in Eq. (4). The next step is 1672, which in one embodiment comprises a final step. Step 1672 is another calculating step, which comprises calculating a wavelength-dependent correction factor C(λ) from the ratio computed in step 1670 for any wavelength λ ranging from twice the minimum to wavelength to a value equivalent to the cutoff wavelength.

Once the correction factor C(λ) is calculated, additional processing steps can be performed according to the invention. For example, a step 1674 may be added for correcting the first order reflectance intensity that was previously recorded. Another step 1676 may be added for determining from the corrected reflectance intensity one or more properties of the wafer, such as a film layer thickness, an optical constant, a doping density, a refractive index, an extinction coefficient, etc. Optionally, a wafer property may be determined by comparing a modeled reflectance intensity to a corrected reflectance intensity. Further, a user may vary one or more modeling assumptions until the corrected reflectance intensity and the modeled reflectance intensity are within a predetermined tolerance. Should a comparison yield results out of tolerance, another option is to vary the measurement locations on the wafer until an acceptable tolerance is achieved.

Method of Compensating for the Non-Constant Wafer Velocity

Depending on the motion of wafer 500 during measurements, irregularities in the ensuing image may occur that cause image distortion. These irregularities result from non-constant wafer velocity during the measurement process. Consider first the case of uniform linear motion in a direction perpendicular to the plurality of locations 634. Depending on the sampling rate, and assuming a full-wafer image, the resulting image is either a circle (which is good), or an ellipse. Whether the semi-major axis of the ellipse is disposed along the direction of motion or transverse to it depends on the linear velocity. In either case, the streets are straight lines, but they do not intersect at right angles. This distortion can be corrected for by a linear remapping of the image using correction factors obtained by determining the length of the semi-major and semi-minor axes of the ellipse. However, there exists a faster method.

Along any chord or diameter extending across the wafer image in the direction transverse to the direction of motion, the distinctive character of the streets allows them to be identified. Using similarly identified streets in adjacent chords, tangents at the intersection of the chord and the streets can be formed. Alternate tangents point in the same direction because of the linear velocity, and they correspond to either horizontal or to vertical rows. These tangents depend only on the linear velocity of the wafer during the measurements, and on the sampling rate. Thus, they can be used to infer the actual wafer motion at the moment of the measurement.

The algorithm of this method is based on extracting information from a single chord. For a wafer moving at a constant velocity, this single measurement applies to the entire wafer. Any chord spanning the wafer thus contains sufficient information to extract the wafer velocity, and therefore to infer how to correct for it.

Since this algorithm applies to a single chord, which is obtained in a short measurement time, it can be applied to small areas of the wafer and to situations where the motion is non-uniform. Examples of such motion include the motion that a wafer undergoes if being manipulated by a robot arm on an R-θ stage, or on a CMP tool undergoing orbital, rotational, or linear motion. Examples of such CMP motion are described in U.S. Pat. No. 4,313,284, U.S. Pat. No. 5,554,064, and U.S. Pat. No. 5,692,947.

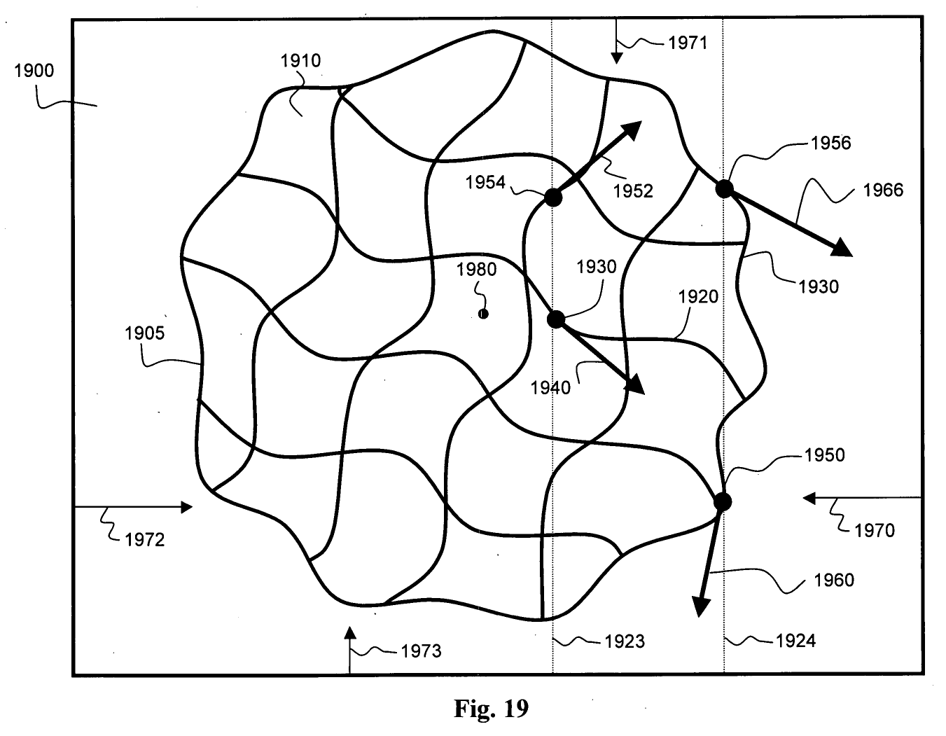

To explain the application of this algorithm to non-uniform motion, consider FIG. 19. Neglecting the effect on intra-die structure (the viable die region), the image may appear as shown in FIG. 19, which shows reflectance data 1900 at an arbitrary wavelength that includes wafer image 1910 having a plurality of street images 1920, and a wafer edge image 1905. Street images 1920 appear as wavy lines due to non-uniform velocity. Since it is known a priori that the streets are actually straight and that there are horizontal and orthogonally oriented vertical streets (albeit rotated at a rotational angle θ), the waviness provides a way to infer the precise amount of velocity non-uniformity. More importantly, the waviness in combination with the fact that the streets are actually straight can be used to correct for the non-uniform velocity. To correct for the distortion in wafer images, selected features are found in key locations and tangent lines to the features are examined at these points. There are two cases to consider: one, where the streets are actually oriented horizontally and vertically (corresponding to rotational angle θ equal to 0°, 90°, 180°, or 270°); and two, where the streets are not so oriented.

For the first case where the streets are oriented horizontally and vertically, note that when the plurality of locations 634 spanning the entire diameter of wafer 500 sweeps across wafer 500, data is recorded from points not on wafer 500 in addition to points on wafer 500. The first step is to find wafer edge image 1905 by sequentially examining points from the edge of reflectance data 1910, for example by examining the points along the dotted line 1924 in the direction of the line designated by the numeral 1973. Reflectance values corresponding to points off the wafer are less than a threshold value, which facilitates finding an edge point 1950 on wafer edge image 1905. Suitable threshold values range from 0.002 to 0.30, but a preferred value is 0.01. (This technique can be applied in other directions, e.g. along directions indicated by lines 1970, 1971, and 1972 to find edges all around wafer image 1910.) By examining data in columns in a similar manner to find adjacent edge points, a tangent line 1960 at edge point 1950 is created. The additional points, in the presence of non-uniform motion, may include some curvature, which can be determined through the use of well-known curve-fitting algorithms. A similar process leads to determining a tangent line 1966 at an edge point 1956. The direction of tangent line 1960 is related to the angle of the edge of wafer 500 and the wafer velocity. This process works for all edge points except at the wafer top, the wafer bottom, and at the midpoints. However, it works at all other points, which makes this technique suitable for correcting for distortion due to non-uniform wafer velocity when the streets are oriented for values of θ equal to 0°, 90°, 180°, or 270°.

For the second case, along dotted line 1923 in FIG. 19, consider a point 1930 in one of street images 1920 along with a tangent 1940 to street image 1920 at point 1930. Tangent 1940 depends on the rotation of wafer 500 during measurements, and of the rotational angle θ of wafer 500 at the moment of the measurement. The same methodology also leads to a tangent 1952 at a point 1954. As with case one, tangent 1940 and tangent 1952 are functions of the velocity and the rotational angle θ.

By obtaining tangents at two or more points on each chord across wafer image 1910, the image data in each chord can be corrected one chord at a time to yield a round wafer with straight streets.

Notch Finding

Once having corrected for distortions in wafer image 1910 it is highly desirable to identify the orientation of wafer image 1910. Since wafers include a notch to identify crystallographic orientation, the very high resolution of images formed with the apparatus of the present invention render this notch visible in wafer image 1910. Since wafers are usually loaded with the notch in a given position, the image of the notch is likely to be in a corresponding position. However, the notch position can differ from the alignment of the wafer patterning by as much a degree or two.

One embodiment of a notch finding method begins with acquiring reflectance data 1900, and detecting wafer edge image 1905 by starting from the top of the image and moving down, as described above. The reflectance at all wavelengths is examined, and the highest reflectance is then compared to the threshold value. After finding wafer edge image 1905 along the top of wafer image 1910, the same edge finding technique is used again to find the bottom and the two sides of wafer image 1910.

Wafer 500 has a center point, the location of which is known to within a couple of millimeters, therefore a wafer image center point 1980 is also known to within a few pixels. Chords across wafer image 1910 may then be used to find the wafer image center 1980 of wafer image 1910. To identify the exact location of wafer image center 1980, the length of a chord extending across wafer image 1910 from a distance several pixels above the estimated location of wafer image center 1980 to several pixels below is calculated. The chord with the maximum length is a first diameter line that extends through the exact location of wafer image center 1980. This process is repeated for vertical chords to obtain a second diameter line. If the first diameter line and the second diameter line are the same (to within a couple of pixels), then the exact location of wafer image center 1980 occurs at the intersection of first diameter line and the second diameter line. If the first diameter line and the second diameter line are not the same (due to having stumbled upon the notch), then the process of obtaining diameter lines along ±45 degree lines is repeated.

Once the edges of wafer image 1910 are located, the notch may be found according to the following method: After determining the wafer center location, begin searching at the top of wafer image 1910 and move by steps either clockwise or counter-clockwise. Each step involves moving either one pixel left or right or one pixel up or down, depending on the location of the wafer center. For example, if starting at the top of wafer image 1910, the wafer center is directly below. If the starting point is not on the edge of wafer image 1910 (an edge point is such that the point above is off the wafer and the point below is on the wafer) then move by steps up or down until reaching wafer edge image 1905. After locating wafer edge image 1905, compute the squared value of the distance from the wafer center to the wafer edge (center-to-edge distance squared) and store it in memory. Then, move one column to the left and again reacquire the edge by searching by steps up and down until the edge is located. Then, compute the center-to-edge distance squared of this new edge point and store it in memory.

Continue moving around the edge and computing the center-to-edge distance squared. Once having gone completely around the edge of the wafer, examine the accumulated center-to-edge distance squared data to find the notch. In one embodiment, the notch may be found by examining the first derivative of the data. The first derivative is highest at the edges of the notch, thus, the maximum value of the first derivative yields a good approximate location for the notch. To more precisely locate the notch once having found the notch using the first derivative, a well-known curve-fitting algorithm may be applied to the tip of the notch.

Orienting Streets—Autorotate Algorithm

When the location of the notch is determined, it may be desirable to align the streets more precisely, for example, to facilitate taking measurements on small features. The present invention further includes such a method, which is called an “auto-rotate” algorithm. This algorithm involves accurately determining the rotational orientation of the spectral image of wafer 1d. This algorithm makes no assumption about spatial orientation, and may be advantageously employed during fabrication processes such as CMP that can affect wafer orientation.

The auto-rotate method takes advantage of the fact that wafer pattern features align orthogonally due to the step and repeat nature of patterns on partially processed integrated circuits. This effect is especially apparent in the streets regions between the die. When the features in the spectral image corresponding to streets are oriented so that they align substantially along the rows and columns of each slice of the spectral image, then a row or column summation preserves a signature indicative of these features. In contrast, if the wafer pattern features are not aligned, then the elements of the resulting row or column summation are representative of an average taken from a much greater variety of areas of the wafer, and thus maintain much less feature differentiation. To quantify this differentiation, and thus the degree to which the wafer features are aligned with the detector rows and columns, the auto-rotate method determines a single “Goodness-of-Alignment” (GOA) value for a given orientation of the image of wafer 1d.

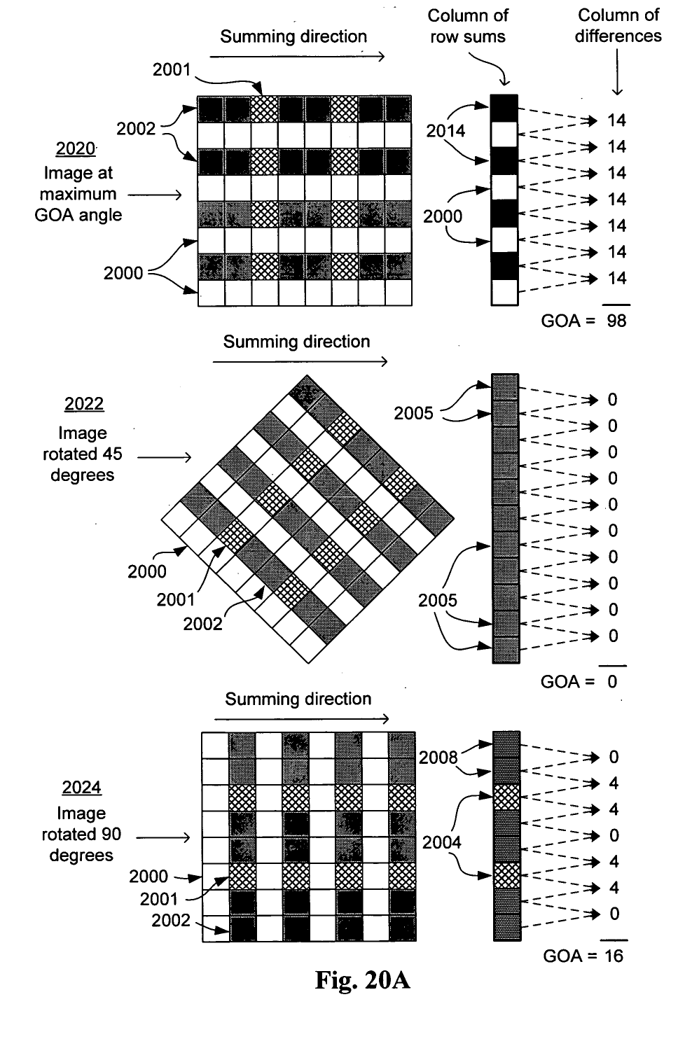

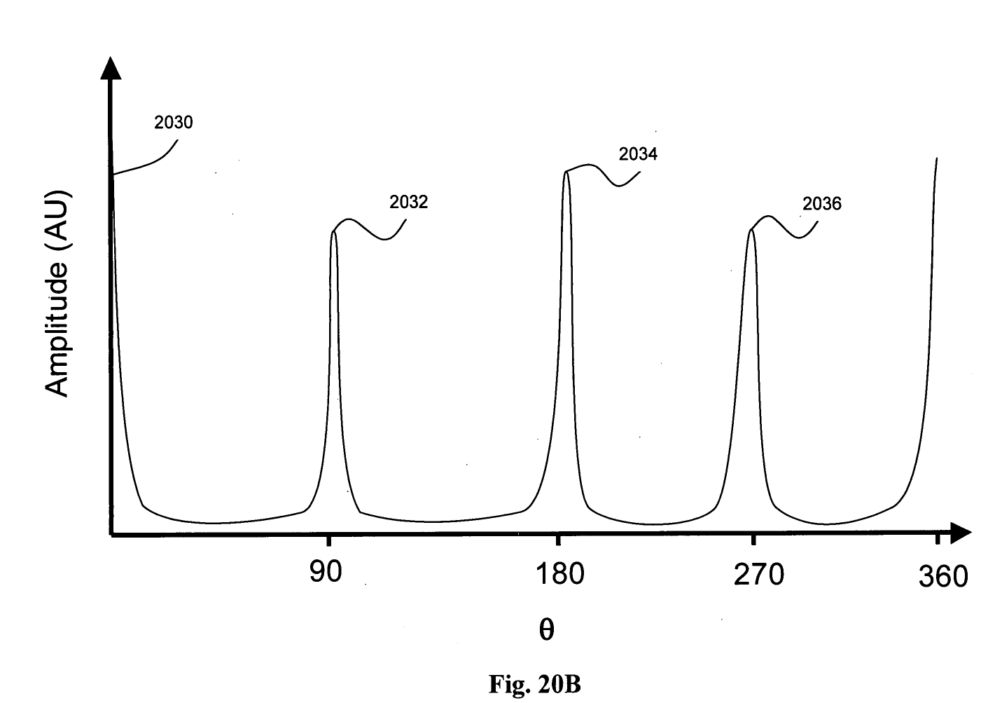

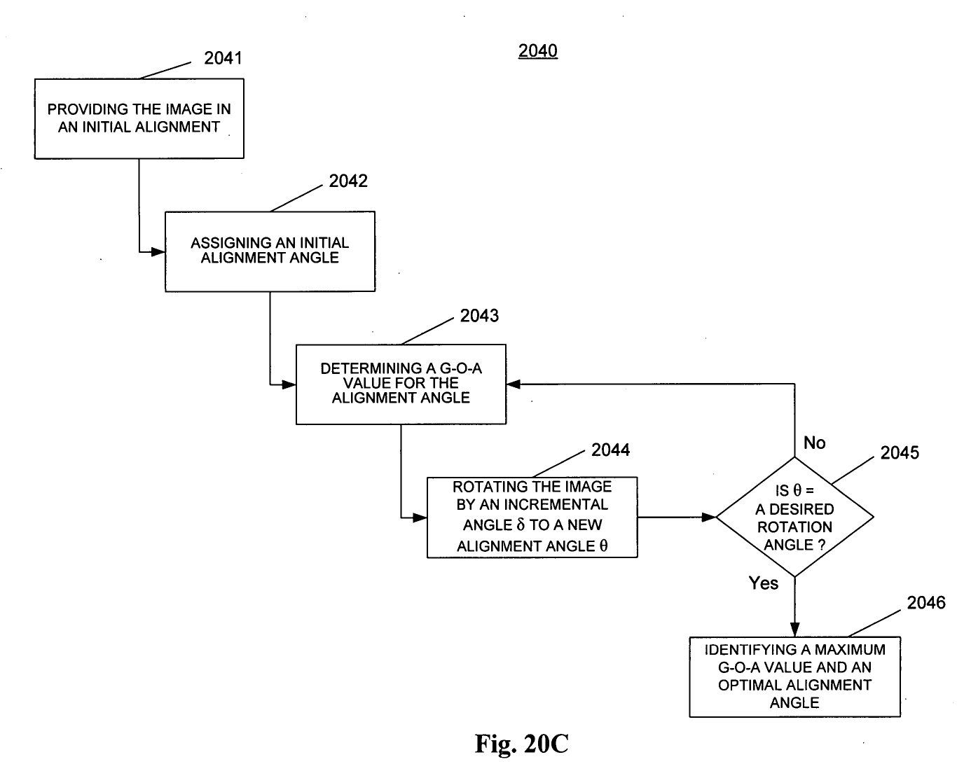

FIG. 20A provides a graphic illustration of GOA determination using row and column summation. The top-most checkerboard FIG. 2020 represents a single slice of a spectral image of a wafer 1d aligned at an angle that is the angle corresponding to a maximum GOA value. That is, spectral image 2020 is constructed from line images resulting from successive one-dimensional scanning in a scanning direction that aligns substantially with the streets of wafer 1d. As a result, horizontal rows of pixels 2000 are taken from areas of wafer 1d that have similar minimal reflectance values. Likewise, pixels 2002, taken from areas of wafer 1d having similar maximum reflectance values also line up in horizontal rows. Certain pixels 2001 having similar medium reflectance values appear in a pattern corresponding to their location on wafer 1d. A row summation of reflectance values is taken in the summing direction as shown, and the result of the summation for all rows forms a column of row sums, which is depicted to the right of image 2020. The darker pixels 2014 in the column of row sums each indicate a relatively high sum of reflectance values in a row summation. The lighter pixels 2000 in the column of row sums each indicate a relatively low sum of reflectance values in a row summation.

GOA may be determined according to the invention by detecting contrast between one or more pairs of adjacent row sums. The example of FIG. 20A discloses one such method, wherein a difference column is derived from the difference in reflectance values between any two adjacent pixels in the column of row sums. Each difference indicates the degree of contrast between a pair of adjacent pixels, and is indicated as a numerical value in the column of differences of FIG. 20A. The numerical values are arbitrary, and are provided for purposes of illustration only. The numerical values in the column of differences may be summed to arrive at a GOA value that is associated with the particular orientation angle of image 2020.

In the example of FIG. 20A, pixels 2000 are assigned a value of 0, pixels 2001 are assigned a value of 1, and pixels 2002 are assigned a value of 2. Each row of image 2020 comprising pixels 2001 and 2002 (such as the top-most row) sums to a value of 14, indicated by a corresponding darker pixel 2014 in the column of row sums. Each row comprising only pixels 2000 sums to zero, as indicated by a corresponding lighter pixel 2000 in the column of row sums. The contrast between any two adjacent pixels in the column of row sums is indicated by each difference value 14 in the column of differences. Summing all difference values yields a GOA value of 98. In this example, 98 represents a maximum GOA value, and indicates very good alignment of wafer 1d.

Image 2022 shows wafer 1d rotated 45 degrees from the angle corresponding to maximum GOA. In this orientation, a row summation taken in the same direction taken for image 2020 yields a very different GOA result. Generally, each reflectance value appearing in the column of row sums will have contributions from a mixture of pixels of type 2000, 2001, and 2002. Thus, each row summation will yield a substantially similar value. For purposes of illustration, each summation value in the column of row sums for image 2022 is represented by a pixel 2005 having a reflectance value of 5. This results in very little or no contrast between any two adjacent pixels 2005, which is reflected in the 0-value entries for each row in the corresponding column of differences. The overall GOA for image 2022 is thus 0, indicating a minimum GOA, or very poor alignment of wafer 1d.

Image 2024 shows wafer 1d rotated 90 degrees from the angle corresponding to maximum GOA. In this orientation, a row summation taken in the same direction taken for image 2020 yields another GOA result. Each row of image 2024 comprising pixels of type 2000 and 2002 (such as the top-most row) sums to a value of 8, indicated by a corresponding dark pixel 2008 in the column of row sums. Each row comprising pixels 2000 and 2001 (such as the third row) sums to a value of 4, as indicated by a corresponding lighter pixel 2004 in the column of row sums. The contrast between any two adjacent pixels in the column of row sums is indicated by a difference value of either 0 or 4, as listed in the column of differences. Summing all difference values yields a GOA value of 16. In this example, 16 represents a peak GOA value less than maximum. A peak GOA value less than maximum indicates alignment of wafer 1d at 90 or 270 degrees from the maximum GOA angle. Note that an alignment angle 180 degrees from the maximum GOA angle will also yield the maximum GOA angle.

FIG. 20B shows an example of the resultant GOA values as a function of rotational angle θ. An angle θ=0 corresponds to a maximum GOA value, where the spatial orientation of the line scans that form the spectral image align with the orthogonal patterns on wafer 1d. Notice that the GOA values have sharp maxima at ninety-degree intervals, which correspond to orthogonal or parallel alignment of line scans with rows and columns of the image of wafer 1d. These peaks are seen in practice. In FIG. 20B, peak 2030 and peak 2034 correspond to vertical streets being oriented vertically, with peak 2034 corresponding to the wafer image being rotated 180 degrees from the orientation that produced peak 2030. Likewise, peak 2032 and peak 2036 correspond to horizontal streets being oriented vertically with peak 2036 corresponding to the wafer image being rotated 180 degrees from the orientation that produced peak 2032. Note also that in this example, peaks 2030 and 2034 have a different amplitude than peaks 2032 and 2036. This is a consequence of applying the method of row and column summation to a wafer having patterns that are not quadrilaterally symmetrical, as in the example of FIG. 20A. However, in most applications, the method of row and column summation can determine that a given wafer orientation at a peak GOA value is one of two, or one of four possible orientations, i.e. 0, 90, 180, or 270 degrees from maximum.

In practice, however, the rotation angle is generally known to within 1-2 degrees (from notch-finding or a priori knowledge), so only a limited range of angles need to be analyzed, and the rotation angle can be determined uniquely to approximately 0.01 degrees of resolution. This resolution allows subsequent position finding steps to be done accurately and reliably.

One application of the algorithm according to the invention is a method for aligning an image of a patterned wafer, as illustrated in FIG. 20C. Method 2040 begins at step 2041, which comprises providing an image of the wafer at an initial alignment. In the next step 2042, the angle of the initial alignment is assigned. The initial angle is merely a reference value, and may be an arbitrary value, or it may be an estimate based on empirical data. Step 2043 follows step 2003. Step 2043 comprises determining a GOA value for the alignment angle. In one embodiment, this step may comprise summing reflectance values along each row to form a sequence of row sums, forming a difference column by calculating the difference between adjacent elements of the sequence of row sums, and computing the GOA value for each alignment angle according to the difference values. When the GOA value is computed, it may be stored in memory, or stored along with its corresponding alignment angle.

Once the initial GOA value is determined, the method proceeds to step 2044. In this step, the image is rotated by an incremental angle 6 to a new alignment angle θ. In one embodiment, incremental angle δ is fixed. In another embodiment, the angle δ varies as a function of a previously determined GOA value. For example, a very low GOA value indicating poor alignment may prompt automatic rotation by a relatively large angle δ; whereas a high GOA value may prompt automatic rotation by a smaller angle δ. This would allow the method to converge more rapidly on a maximum GOA. In another embodiment, a control algorithm may be employed to achieve a critically damped convergence to maximum GOA.

The method then proceeds to the decision step 2045, which compares the angle θ to a desired rotation angle. If the angle θ is less than or equal to the desired rotation angle, the method loops back to step 2043 and continues forward. If, however, the angle θ equals the desired rotation angle, then angle δ is set to zero (i.e. the rotation process ends) and the method proceeds to step 2046. A desired rotation angle may be a predetermined maximum angle, or it may be the angle corresponding to a desired GOA value. In step 2046, a maximum GOA value and an optimal alignment angle are determined. The maximum GOA value is determined from the population of GOA values calculated and stored during repetitive executions of step 2043. The optimal alignment angle is the angle associated with the GOA value that is determined to be the maximum.

In another embodiment, the GOA value may be determined by the following algorithm: summing reflectance measurements in two or more rows to form a column of row sums; detecting the contrast between one or more pairs of adjacent row sums; and computing the GOA value for each alignment angle according to the detected contrast.

Determining the orientation of the image of wafer 1d involves applying the above algorithm to the image of wafer 1d over a range of image rotations to generate a series of GOA values for different rotational orientations of the image of wafer 1d. The rotations are performed after applying an appropriate mathematical transformation to the image of wafer 1d. Forming the column of row and difference sums to detect contrast is just one example of such a transformation. Reflectance values from a spectral image of wafer 1d may be stored in the memory of computer 10 as digital signals, and processed using any appropriate digital processing technique to analyze the spectral image and determine wafer orientation or other some other characteristic of interest. For example, pixel contrast may be detected by integrating a Fourier transform of data representative of a column of row sums, and GOA may be computed therefrom. Many such processing techniques are well known in the art.

In another embodiment, orienting the streets in the auto-rotate algorithm involves using light in a single narrow band, rather than using all of the light or a relatively wide spectrum. In one example, the wavelength of light used is 660 nm.

It is also possible to create a vertical or horizontal orientation line using more than one wavelength, or to use multiple wavelengths, i.e., spectra arising from light passing through multiple bandpass filters. Though summing the optical reflectance at each wavelength used is possible, summing the ratio of the optical reflectance at each of two wavelengths allows the creation of an orientation line with additional pattern dependent structure. One example is to use a relatively blue wavelength, for example 410 nm, and a relatively red wavelength, e.g. 660 nm.

Another embodiment of the autorotate algorithm includes an optional step for obtaining a die signature. Once the image of wafer 1d has been oriented, pattern recognition techniques are used to identify in wafer image Id the locations of portions, e.g. quadrants of individual die. Unless each die is exactly symmetric about its center point, some degree of asymmetry can be detected because the reflectance in different quadrants of each die typically vary from quadrant to quadrant. These variations from quadrant to quadrant constitute a signature indicative of the orientation of each die. In another embodiment, the algorithm may comprise an additional technique that uses the ratio of reflection intensities at different wavelengths (as described above) to detect characteristic asymmetry.

Rotational Auto-Rotate Method

Yet another approach to obtaining an oriented wafer image is to analyze an image of a portion of a patterned wafer, where the portion of the wafer being analyzed includes a street at the radial distance from the wafer center, but at an unknown angle. There are two situations to consider. In both situations, the nominal location of the wafer center is known to within tens of microns, but the notch is at an unknown angle albeit at a known radius. In the first situation the wafer center lies within a center die, and in the second situation a street (either horizontal or vertical) traverses the center of the wafer. This rotational method of orienting wafers involves using system 100 to measure reference wafers and non-reference wafers with the same pattern as the reference wafer.

The rotational method includes positioning line imaging spectrometer 11 so that it images a portion of the wafer along a line perpendicular to a radial line extending from the center of wafer 1d to the edge of wafer 1d. Line imaging spectrometer 11 substantially straddles the radial line. If dealing with the first situation where the center of the wafer falls within the center die, line imaging spectrometer 11 is disposed to image a portion of wafer 1d at a half-die width equal to one half of the die height away from the wafer center. Thus, for some rotational angle θ the reflectance data pertains to light reflecting substantially from a street portion of wafer 1d. If dealing with the second situation, line imaging spectrometer 11 is disposed to straddle and to image the center of wafer 1d.

The rotational method then involves rotating the wafer about its center point with line imaging spectrometer 11 held at the half-die width (situation one) or at the wafer center (situation two). While rotating the wafer, computer 10 records reflectance data sensed by line imaging spectrometer 11. For each rotational angle θ computer 10 forms an orientation signal by summing all the pixels in each row over all wavelengths.

A plot of the orientation signal as a function of rotational angle has peaks corresponding to the street being optimally aligned with the portion of wafer 1d being imaged. For situation one, two peaks are present, thus providing orientation to within ±180 degrees. For situation two, four peaks are present if the wafer center aligns with the intersection of both vertical and horizontal streets; otherwise only two peaks are present.

To account for situations where the known uncertainty in the portion of wafer 1d being imaged results in this portion not being substantially aligned with the streets of wafer 1d, a reference method is used. The reference method involves using the aforementioned rotational method to obtain a clear orientation signal referred that serves as a reference orientation signal, and is stored in memory. A subsequent measurement on another wafer having the same pattern on it is then measured to obtain a test orientation signal that is compared with the reference orientation signal. The test orientation signal is likely to exhibit a poorer quality indication that line imaging spectrometer 11 is aligned with the streets due to the uncertainty in the location of the wafer center. However, as long as the test orientation signal exhibits well-defined peaks, the reference method can be used to determine the proper orientation of the wafer.

Numerous techniques can be used to compare the test orientation signal with the reference orientation signal. One such technique is to use a one-dimensional cross-correlation function.

$${C}_{tr} ( θ ) = \overline{t ( n ) r ( n - θ )} = \frac{1}{N} {\sum }_{n = 0}^{N - 1} t ( n ) r ( n - θ ) \qquad ( 5 )$$

where t(n) and r(n) are the test and reference orientation signals respectively, N is the number of pixels in a row, and θ is the correlation angle. The angle corresponding to maximum correlation corresponds to the desired rotational angle. Another comparison technique involves calculating a difference between t(n) and r(n−θ) and identifying the minimum such difference corresponding to the desired rotational angle. Additional techniques using the method of least squares can also be used.
Using Software to Calibrate each Individual Column of the 1-D Spectrometer Independently with a Monochromatic Light Source

The process of matching model spectra to measured spectra requires that the measured spectra are correct. It is also advantageous to perform the following calibration procedure to ensure that measured spectra are indeed mapped to the proper wavelengths. To perform such a calibration, the apparatus used for correcting for second order spectral overlap is used. In particular and referring to FIG. 1, light source 3 of system 100 is replaced with an LED or with broadband light passed through a bandpass filter to produce light with a 10-20 nm bandwidth. Consider the implementation where two-dimensional imager 8 is a CCD, the spatial dimension is the horizontal dimension, and the spectral dimension is the vertical dimension. Light from the 10-20 nm light source should give a uniform response from two-dimensional imager 8. In other words, the row element exhibiting the maximum response along the columns corresponding to the spectral dimension should be the same in each column across the spatial dimension of the array. Illumination with light having a 10-20 nm bandwidth is important so that several pixels sense the light, and well-known curve fitting algorithms can be used to find an exact peak location, thus improving the accuracy of the calibration procedure. If the response is non-uniform across two-dimensional imager 8, then the wavelength can be corrected by fitting the measured response to a second order polynomial.

Repeating this calibration procedure at several wavelengths in the range of sensitivity of two-dimensional imager 8 maximizes the accuracy of the calibration. This calibration process can be done at different wavelengths sequentially, or simultaneously.

Decreasing Minimum Pad Size Requirements

The evolution of integrated circuit (IC) technology has led to ever-decreasing critical dimensions. Associated with this reduction has been a reduction in the size of test sites, which are bond-pad like features that are typically large compared to device features. Typically, many such sites are located on each wafer on which ICs are being fabricated. Since most existing tools for measuring test sites involve the time-consuming and hence expensive serial data acquisition, few test sites are measured due to the time-consuming nature of existing metrology techniques. The inventions described above and as shown in FIG. 1 and FIG. 3, as well as those disclosed in U.S. patent application Ser. No. 09/899,383, and U.S. patent application Ser. No. 09/611,219, describe how to obtain large numbers of measurements on bond pads as small as 100 um. In spite of these inventions, there remains a need for a capability of accurately and reliably measuring thin films at test sites on wafers, where the test sites are as small or smaller than 50 um.

To appreciate the benefits of several techniques described below to measure smaller test sites, it is useful to recall that optical systems such as those described in the present invention involve an object (e.g. wafer) and a collection of optical elements disposed to create an image in an image plane that coincides with the sensing portion of a multiple-pixel, two-dimensional imager. Such systems also function in reverse, i.e., the collection of optical elements also images the multiple-pixel, two-dimensional imager (now viewed as an object) onto a second image plane that coincides with the plane of the wafer. Thus, one can view such a system from the perspective of a wafer image on the multiple-pixel, two-dimensional imager, or as a collection of pixel images on the wafer.

To provide accurate and reliable measurement capability on such test sites requires that a measurement spot size be as small or smaller than the test site, and that one or more measurement spots lie substantially within the test site. The measurement apparatus one uses determines this capability. The minimum test site area that can be measured is determined by the measurement spot size, which is equal to the size of the “pixel image” that is imaged onto the wafer surface by the imaging system 100. The pixel image size is primarily determined in the present invention in the horizontal direction by the pixel width multiplied by the product of the magnification of lens assembly 4 and the magnification of lens assembly 6, and in the scan direction by the slit width multiplied by the magnification of lens assembly 4.

The ability of a measurement system to measure a test site also depends on the measurement spot density, i.e., the number of measurements made per unit area on wafer 1d. In particular, using the apparatus of the present invention, the measurement spot density is determined primarily by the density of pixel images in the horizontal direction and the scan speed in the scan direction. Clearly, the measurement spot size and the measurement spot density are affected by the magnifications of the lenses 4 and 6. Hereinafter, the discussion addresses the effects of other factors on the measurement spot size and the measurement spot density. Therefore for simplicity we assume unity magnification for lens assemblies 4 and 6. This assumption allows us to ignore the distinction between the pixel and slit sizes and the pixel image size. However, it is not necessary to limit the scope of the present invention to unity magnification of lens assemblies 5 and 6 to appreciate the benefits of the present invention.

Ensuring that one or more measurement spots lie substantially within a test site involves either performing extremely precise measurements at locations whose position is known a priori to a high degree of precision (which is expensive and time-consuming), or by increasing the measurement spot density and rapidly sifting through the measured data. The present invention involves performing sufficiently numerous measurements in a very short period of time such that the very density of measurements combined with the small measurement spot size of individual measurements ensures that accurate measurements at desired test sites are made. Methods already described in U.S. patent application Ser. No. 09/899,383, and U.S. patent application Ser. No. 09/611,219, address the issue of efficiently sifting through measurement data to extract measurements at desired test sites.

Standard solid-state imagers have rectangular pixels whose width is equal to the horizontal pixel pitch. This relationship implies a 100% fill factor, i.e., there is no portion of the sensing region of the imager that is not sensitive to light. However, for a given imager, improving the measurement spot size requires innovation.

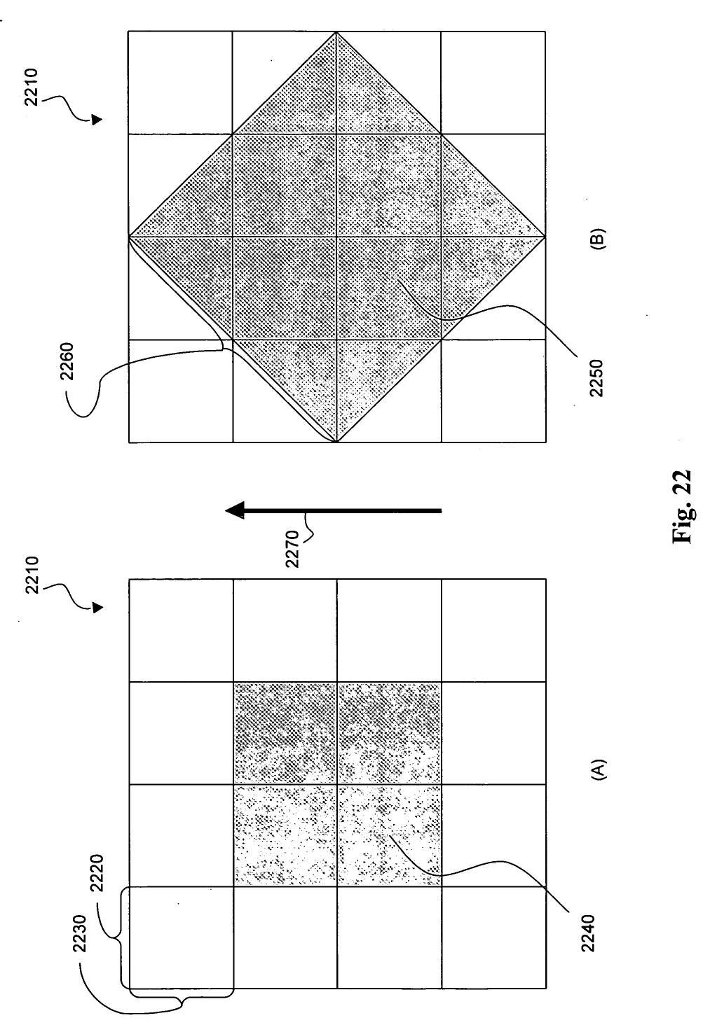

The measurement spot size depends in part on the orientation of the image of the measurement site compared to the orientation of the pixels in two-dimensional imager 8. FIG. 22(A) shows a 4×4 portion of a pixel array 2210 of two-dimensional imager 8 that has a 100% fill factor, and where each pixel has a horizontal dimension 2220 and a vertical dimension 2230. If the measurement sites are optimally oriented, as shown in FIG. 22(A), then the minimum measurement site image size is twice the pixel size. (Smaller site areas could straddle two pixels so that neither pixel would sense light from a single film stack, thus forming difficult or impossible to decipher measurements.) Pixel array 2210 moves in a scan direction indicated by an arrow designated by the numeral 2270. Superimposed on array 2210 is a measurement site image 2240. If the measurement site image size is any less than two times horizontal dimension 2220 or two times vertical dimension 2230 then there is a risk that a measurement will not include at least one pixel that is completely covered by the measurement site image.

However, it cannot be assumed that the measurement sites are optimally oriented since there is uncertainty in the orientation of wafer 1d on platform 2, even if wafer 1d is oriented prior to being placed on platform 2. The worst-case scenario is that the measurement sites are oriented at a 45-degree angle, as shown in FIG. 22(B), which shows a measurement site image 2250 oriented at a 45-degree angle to the pixels of pixel array 2210. Measurement site image 2250 has an edge dimension 2260 that has a minimum length of 2\sqrt{2} times horizontal dimension 2220.

To cope with the worst-case scenario, and to meet or exceed the minimum measurement spot size, the active area of the pixels that receive light must be reduced. The present invention includes several techniques that provide for this capability.

Pixel Masking

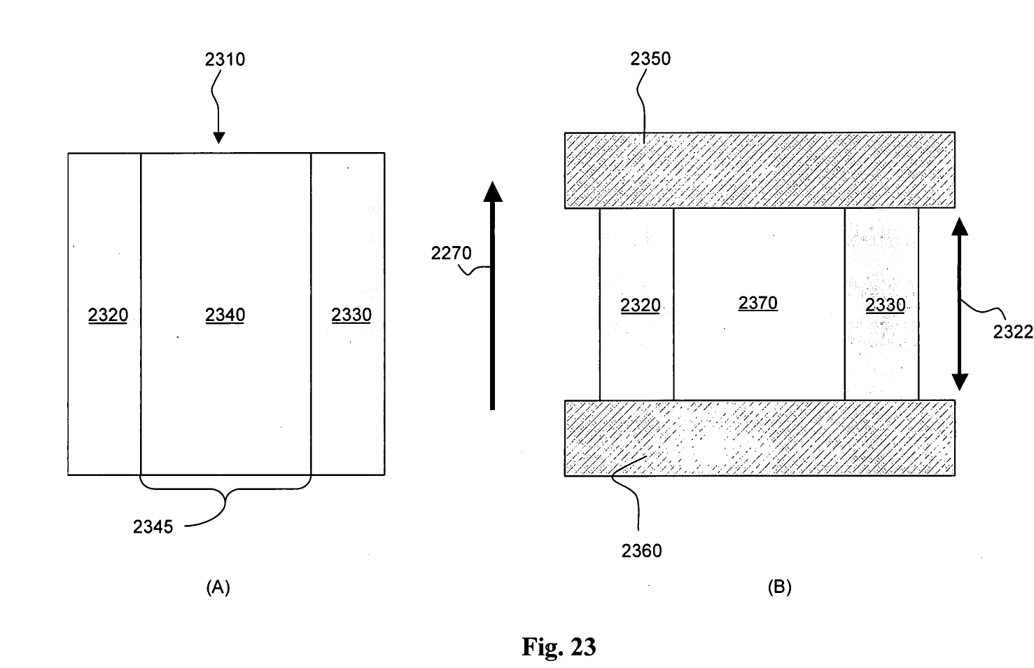

Decreasing the active area of the pixels that receive light can reduce the measurement spot size. For optimal results, this approach involves reducing the active area in both the horizontal and vertical directions. Masking the pixel area can achieve this reduction in the horizontal dimension. FIG. 23(A) shows a pixel 2310 to which an opaque material has been applied to form a mask 2320 and a mask 2330 that block light from reaching the active portion of pixel 2310, thus forming active area 2340 having a width 2345. Skilled artisans will recognize that mask configurations other than that shown in FIG. 23(A) are possible. In this embodiment, placing mask 2320 and mask 2330 near the outer edges of pixel 2310 has several advantages. Such placement optimizes the sensitivity of pixel 2310 to light, reduces electrical crosstalk between adjacent pixels, and reduces resolution degradation caused by non-ideal optics (such as those that may be found in lens assemblies 4 and 6). The opaque material that forms mask 2320 and mask 2330 may be deposited during the fabrication of two-dimensional array 8, using standard IC fabrication methods. Materials such as metals (aluminum, gold, silver, etc.) are suitable opaque materials. Advantageously, such materials are anti-reflection (AR) coated to suppress reflections.

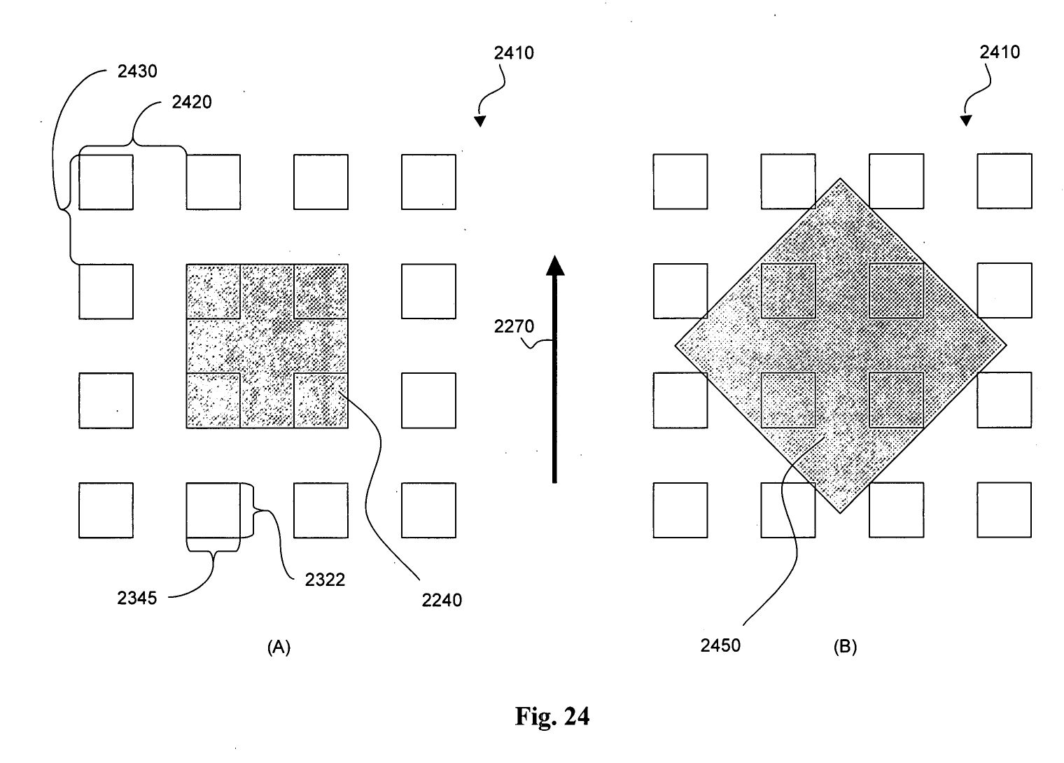

In the vertical dimension masking can also be used to reduce the pixel area. However, it is advantageous to adjust the slit width of slit 5, which has a blade 2350 and a blade 2360 separated by a height 2322 as shown in FIG. 23(B). The slit width of slit 5 is height 2322. This process results in an active area 2370 that is substantially smaller than the original active area of pixel 2310. Assuming that the resulting active area 2370 is square, then the minimum measurement site size is a times the sum of width 2345 plus height 2322. FIG. 24(A) shows a 4×4 portion of a pixel array 2410 of a two-dimensional imager that is identical to two-dimensional imager 8 except for the pixels being masked as shown in FIG. 23.

Pixel masking results in a decrease in fill factor to the product of height 2322 and width 2345 divided by the product of horizontal dimension 2220 and vertical dimension 2230. If height 2322 and width 2345 are one half of horizontal dimension 2220 and vertical dimension 2230, respectively, then the ensuing fill factor is 25%.

FIG. 24(B) shows a measurement site image 2450 oriented at a 45-degree angle to the pixels of pixel array 2410. Although measurement site image 2450 is nominally the same size as measurement site image 2250, measurement site image 2450 easily fits over four pixels in pixel array 2410, with considerable tolerance. Should rectilinear and/or rotational misalignment occur, there is a high probability that measurement site image 2450 will still fully cover at least one pixel.

FIG. 24 shows the reduction in measurement spot size due to reducing each edge of active pixel area by one half, which leads to a 25% fill factor. Further reductions in active pixel area are possible, albeit with a corresponding decrease in the total amount of light that reaches the pixels. This reduction in light intensity can be compensated for by increasing the intensity of light source 3, or by using a more sensitive detector.

One very significant benefit to pixel masking is that the resulting reduced measurement spot size is much more likely to lie entirely on a single film stack regardless of the orientation of any given measurement site relative to the pixels in imager 8. In contrast, large measurement spot sizes are much more likely to bridge two different film stacks, which result in a reflectance measurement that is difficult to decipher.

In one embodiment, the scan speed is the same as nominal speed. As wafer 1d moves, light from light source 3 reflects off wafer 1d and enters line imaging spectrometer 11 of system 100, where two-dimensional imager 8 has been replaced with two-dimensional imager 2410. Computer 10 receives spectral data from line imaging spectrometer 11, and generates spectral images of wafer 1d from which the film thickness of a film at desired measurement sites is determined, as described in U.S. patent application Ser. No. 09/899,383, and U.S. patent application Ser. No. 09/611,219.

Over-Sampling

It is not practical to determine with absolute certainty that any given measurement spot will occur at an exact location on a wafer being measured. One reason for this uncertainty is a consequence of the small spot size, the positional tolerances involved in wafer positioning, and in mask alignment during normal processing conditions. Other reasons include tolerances associated with synchronizing data acquisition and wafer motion or positioning during data collection.

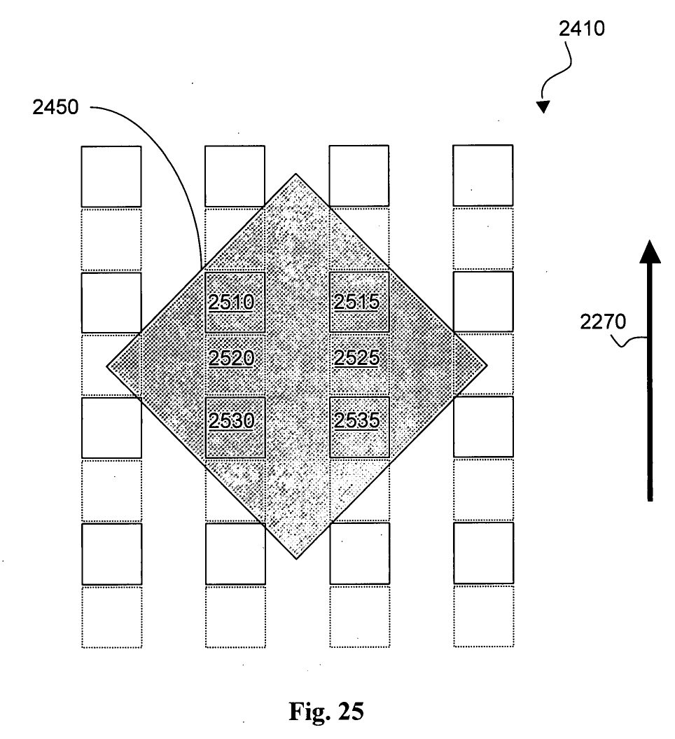

One method according to the invention for increasing the probability that a measurement of wafer 1d using system 100 actually results in a measurement of a desired measurement site is to increase the measurement spot density by reducing the scan speed relative to the data acquisition rate. Although it is intuitive to set the scan speed to result in a measurement spot density that is equal in directions both parallel to and perpendicular to the scan direction, decreasing the scan speed by a factor of two while maintaining the data acquisition rate increases the measurement spot density by a factor of two. FIG. 25 shows measurement site image 2450 as well as pixel array 2410 at two sequential integration times. The first integration time corresponds to the dotted lines, and the second integration time corresponds to the solid lines. During the first integration time, a pixel 2520 and a pixel 2525 are entirely within measurement site image 2450. However, during the second integration time, a pixel 2510, a pixel 2515, a pixel 2530, and a pixel 2535 are entirely within measurement site image 2450. An ensemble image comprising images recorded at both the first and second integration times leads to an image that includes six pixels that are covered entirely by measurement site image 2450, which is a significant increase in the probability that a single sweep of measurements across wafer 1d results in high quality measurements at desired test sites. Further reducing the scan speed can lead to the case of “overlapping”, i.e., where the measurement spots begin to overlay in the scan direction. Overlapping further reduces the minimum measurement site size.

The example just described serves to show how a 50% reduction in scan speed doubles the number of measurements made during a single sweep across wafer 1d using system 100, thus increasing the spatial resolution of measurements. Further decreasing the available light sensitive area by scaling each pixel down is one way to obtain additional resolution. Another way to obtain further increases in spatial resolution is to further reduce the active area of pixels by masking more of each pixel. Reducing height 2322 by adjusting blade 2350 and/or a blade 2360 appropriately leads to nominally square light sensitive regions. Further reducing the scan speed results in more measurements on wafer 1d. Depending on how much masking is done it may be necessary to increase the intensity of light generated by light source 3.

In one embodiment, the scan speed is reduced to one half of its nominal speed. As wafer 1d moves, light from light source 3 reflects off wafer 1d and enters line imaging spectrometer 11 of system 100, where two-dimensional imager 8 has been replaced with two-dimensional imager 2410. Computer 10 receives spectral data from line imaging spectrometer 11, and generates spectral images of wafer 1d from which the film thickness of a film at desired measurement sites is determined, as described in U.S. patent application Ser. No. 09/899,383, and U.S. patent application Ser. No. 09/611,219.

Row Staggering

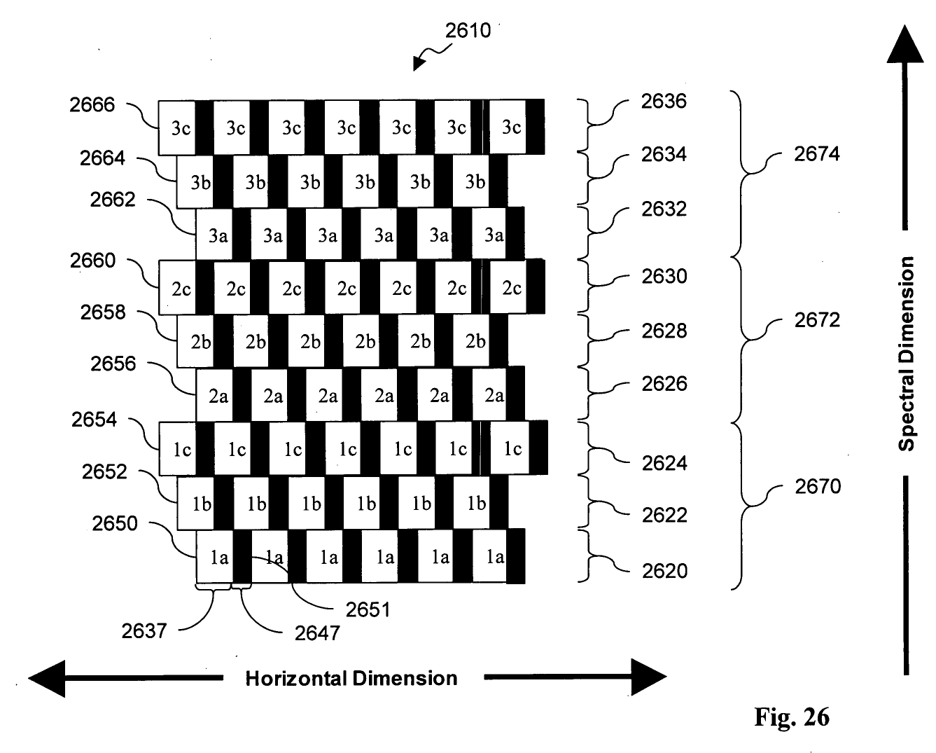

One limitation of simply over-sampling as described above is that there is no increase in the measurement spot density in the horizontal direction. To mitigate this problem, two-dimensional imager 8 of system 100 is replaced with a two-dimensional imager having a plurality of staggered rows of masked pixels that can be used like a single horizontal row with a higher pitch density. Preferably, each pixel is masked on a single side, as described above and using known methods. Adjacent rows are offset by the width of the mask. An example of a two-dimensional imager with staggered rows is shown in FIG. 26, which shows a portion of two-dimensional imager 2610 having a three-fold increase in measurement spot density in the horizontal direction. In use, pixels disposed along the horizontal direction correspond to a spatial dimension and pixels disposed along the vertical direction correspond to the spectral dimension, as indicated in the figure. Pixels in every third row sense light from the same physical location on wafer 1d, but at different wavelengths. The ensemble of spectral measurements at all wavelengths available from every third vertically aligned pixel constitutes the spectrum of light reflected from the physical location on wafer 1d.

In one embodiment, two-dimensional imager 2610 includes a pixel row 2620 that includes a pixel 2650 having a width 2637 with a mask 2651 having a width 2647. Two-dimensional imager 2610 further includes pixel rows 2622, 2624, 2626, 2628, 2630, 2632, 2634, and 2636. Pixel rows 2620, 2622, and 2624 form a row group 2670. Pixel rows 2626, 2628, and 2630 form a row group 2672. Pixel rows 2632, 2634, and 2636 form a row group 2674. Likewise, pixel row 2622 and pixel row 2624 of row group 2670 include a pixel 2652 and a pixel 2654, respectively. Pixel row 2626, pixel row 2628 and pixel row 2630 of row group 2672 include pixels 2656, 2658, and 2660, respectively. Pixel row 2632, pixel row 2634, and pixel row 2636 of row group 2674 include pixels 2662, 2664, and 2666, respectively.

Each pixel dimension as well as the dimensions and position of the mask on each pixel of each row is identical to that of pixel 2650 and mask 2651. Width 2647 of mask 2651 is preferably chosen to be one third of the width of pixel 2650 so that pixels in every third row align vertically. However, it is not necessary that width 2647 be one third of the width of pixel 2651; other fractional proportions such as one half and one fourth also work, and lead to pixels in every second or fourth row, respectively, being aligned.

Preferably, two-dimensional imager 2610 includes 32 row groups. If each row group includes three pixel rows per row group, then 96 rows are needed to provide spectral measurements at 32 distinct wavelengths. Individual pixel rows receive light at slightly a different wavelength than adjacent pixel rows. This difference is small, and even though physically adjacent points have 32-point spectra associated with them, there is a slight shift in wavelength from site to adjacent site. This difference is inconsequential. In practice, such differences can be accounted for by calibration procedures.

In one embodiment, the scan speed is reduced to one third of its nominal speed. As wafer 1d moves, light from light source 3 reflects off wafer 1d and enters line imaging spectrometer 11 of system 100, where two-dimensional imager 8 has been replaced with two-dimensional imager 2610. Computer 10 receives spectral data from line imaging spectrometer 11, and generates spectral images of wafer 1d from which the film thickness of a film at desired measurement sites is determined, as described in U.S. patent application Ser. No. 09/899,383, and U.S. patent application Ser. No. 09/611,219.

Wafer Paddle Motion Damper

The process of acquiring high-speed, high-density reflectance data from a patterned wafer involves sensing light reflected from the surface of the patterned wafer. Since the wafer must move relatively to light source 3 and line imaging spectrometer 11, there is opportunity for such relative motion to degrade the sensed reflectance due to increased measurement area. Typically, such unwanted motion is in a direction transverse to the X direction 12.

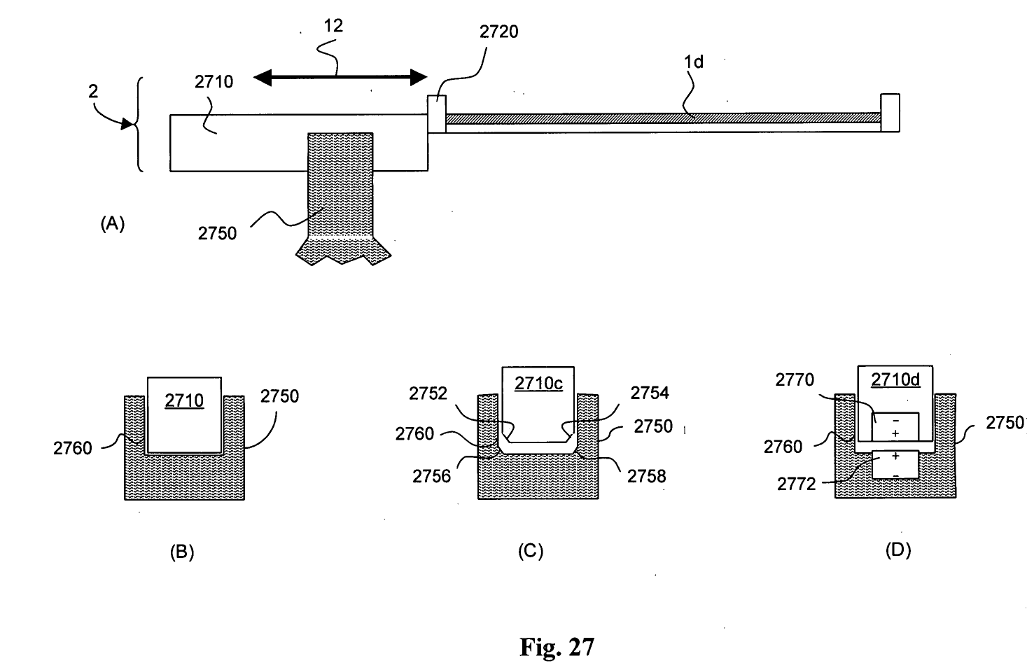

To suppress such undesirable motion the present invention provides for a mechanism that reduces this motion. As shown in FIG. 27(A), platform 2 of system 100 further includes an arm 2710 to which a wand 2720 is mechanically attached. Wand 2720 serves to secure wafer 1d. In addition, platform 2 further includes a fixture 2750 that serves to limit unwanted motion while simultaneously allowing wafer 1d to be translated in the X direction 12 upon command from computer 10. FIGS. 27(B) through (D) show three exemplary ways to limit unwanted motion.

FIG. 27(B) shows fixture 2750 in cross section, and in particular shows a groove 2760 that has been formed in fixture 2750. Groove 2760 is formed to conform to the shape of arm 2710 so that as computer 10 causes translation mechanism 53 to move wafer 1d, arm 2710 moves along fixture in the X direction 12. Motion in directions transverse to the X direction 12 is suppressed by groove 2760 and by slight downward pressure applied by translation mechanism 53 to keep arm 2710 in groove 2760.

Though groove 2760 is shown as being rectangular, a wide variety of other shapes also work provided that they conform to the shape of arm 2710. Example cross-sectional shapes include round, triangular, etc. In practice, only nominal shape conformality is needed; provided that at least two portions of groove 2760 are present that provide stable supporting points that limit the transverse motion of arm 2710 in groove 2760, the objective of stabilizing the motion of wafer 1d is satisfied. The use of Teflon™ or wheels or bearings can also be used to reduce the sliding friction.

FIG. 27(C) shows a variation on the embodiment shown in FIG. 27(B) wherein arm 2710 has been modified to include a beveled edge 2752 and a beveled edge 2754, thus forming arm 2710c. Fixture 2750 has been likewise modified to include a beveled edge 2756 and a beveled edge 2758 that match beveled edges 2752 and 2754 respectively. The addition of these beveled edges further restricts translational motion while facilitating the ability of translational mechanism 53 to position arm 2710 within groove 2760 of fixture 2750.

FIG. 27(D) shows yet another way to stabilize transverse motion. An arm 2710d is formed by modifying arm 2710 to include a magnet 2770 disposed substantially within arm 2710d, as shown in FIG. 27(D). Magnet 2770 is oriented so that one pole, designated with a “+” in FIG. 27(D), is oriented away from arm 2710d. Fixture 2750 is formed by disposing a magnet 2772 within fixture 2750 so that magnet 2772 is flush with the surface of a groove 2760, as shown in the figure. Magnet 2772 is oriented so that one pole, designated with a “+” in FIG. 27(D), is oriented toward arm 2710d. Essential to the operation of this embodiment is that like poles face each other so as to form a magnetic bearing.

In operation, translation mechanism 53 presses arm 2710d into groove 2760 and the opposing force induced by the close proximity of like poles in magnets 2770 and 2772 along with the structure of groove 2760 suppresses transverse motion.

Considerable variations on the embodiment shown in FIG. 27(D) are possible. The placement of additional pairs of magnets in the sidewalls of groove 2760 with like poles facing each other further stabilizes transverse motion. In addition, placing pairs of magnets in groove 2760 with opposite poles facing each other can be used advantageously to provide an attractive force. Such a construct, in combination with pairs of magnets with like poles facing each other, can be used to draw arm 2710d into groove 2760, and yet keep arm 2710d from actually contacting groove 2760 due to the magnetic bearing effect. This combination adds further stability against transverse motion.

The magnetic fields necessary to accomplish such stabilization are small. Likewise, so too are the relative speeds, approximately 40 mm/s. Thus, any induced currents are small and unlikely to cause damage to devices being formed in wafer 1d, especially since wand 2720 is typically made from non-conducting materials such as Teflon™, or is otherwise electrically isolated from arm 2710.

Looking Thorough a Viewport

The present invention further provides enhanced visibility of wafer 1d when using system 101 in FIG. 3. In the absence of specific design, implementing viewport 18 with a bi-planar glass plate, as is the practice in the art, leads to a degraded image due to wavelength dependent optical path length differences (dispersion) as light refracts through viewport 18. Coating viewport 18 with an AR coating is not sufficient to solve the problem. To overcome this problem, viewport 18 is treated as an integral component of the optical elements used in system 101. Furthermore, the optical design parameters of lens assembly 4, and if necessary, lens assembly 6, are adjusted to compensate for the dispersion in viewport 18. Thus, designing lens assembly 4 so that is takes into account the optical effects of viewport 18 can result in non-degraded images. Such design parameters can be optimized using commercially available software such as ZEMAX produced by Zemax Development Corporation of San Diego, Calif.

Optionally, viewport 18 can be viewed as having a top surface 18t with curvature Rt, and a bottom surface 18b having curvature Rb. The design process can be performed to optimize curvature Rt of top surface 18t, and/or optimizing curvature Rb of bottom surface 18b.

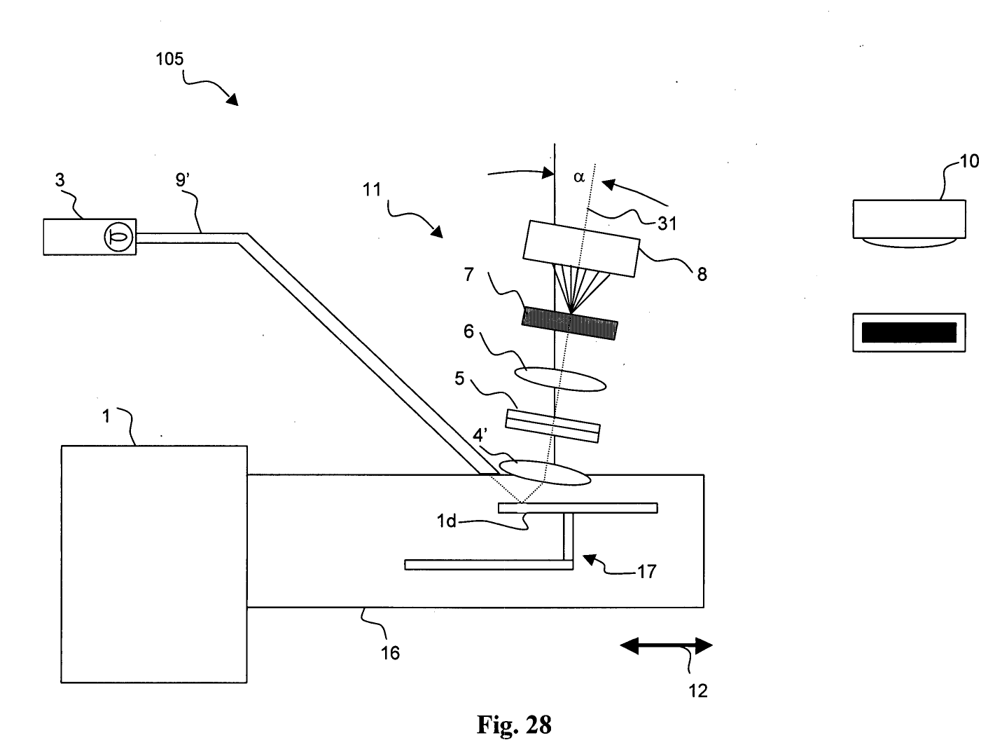

In an alternative embodiment, lens assembly 4 of line imaging spectrometer 11 and viewport 18 are integrated into a single piece. This approach is shown in FIG. 28, which shows system 105, which is identical to system 101 except that lens assembly 4 and viewport 18 have been replaced with lens assembly 4′ that combines the functionality of lens assembly 4 and viewport 18 into a single element. Fiber bundle 9 has also been modified to a form 9′ that it is optically and mechanically coupled to transfer chamber 16. Lens assembly 4′ includes one or more lenses, each having front and back surfaces having curvature that is optimized to provide a clear image of the portion of wafer 1d being illuminated by light source 3. The general operation of system 105 is identical to that of system 101.

Dual-Offner

The need for obtaining measurements on very small measurement sites on wafers drives two conflicting factors. One factor is the need for sensing light from very small areas without optical contamination from nearby areas, and the second factor is the need for simple, low-cost optics. Conventional single-spot microscope-based measurement systems typically use refractive (i.e., transmissive) lens systems to provide a small, well-defined measurement spot. These lens systems are complex and expensive because the refractive index of the glass materials used to make the lenses varies with wavelength, and the ability to image a small spot over a wide range of wavelengths requires a lens system that consists of numerous (typically five or more) precision lenses positioned in a low-tolerance assembly.

The optical system for an imaging spectrometer is even more complex and expensive because the size of the area to be precisely imaged is several orders of magnitude larger than that of a single-spot system. This is because each line image consists of thousands of the single-spot sized images. The optical systems of the resolution required for imaging micron-sized structures such as those found on ICs include three or more concave and convex mirrors that are set at precise angles to one another. These requirements increase the cost and complexity of assembly due to the number of components and their tight alignment tolerances. In addition, such systems typically include at least one mirror element that is not spherical (i.e., that is aspherical), which adds significantly to the cost. The combination of angled positioning and aspherical mirrors lead to prohibitive cost and complexity that are inconsistent with a low-cost, high performance measurement system.

It is possible, however, to circumvent the above problems by taking advantage of two essential factors. First, the detector pixel size is comparable to the size of the measurement pads, which means that imaging with a magnification of approximately 1:1 is needed. Second, optical systems that use reflection alone eliminate the dispersion associated with refractive optics. However, the use of reflective surfaces alone is insufficient to address the above problems. Such surfaces must also minimize optical defects such as spherical aberration and coma; otherwise the problem of wavelength dispersion is replaced by another problem, that of image distortion.

There exists a simple two-element, concentric, spherical, reflective optical system that provides 1:1 magnification and the wide-wavelength-range resolution required for the present invention. This two-element reflective system is called an Offner system, and is described in U.S. Pat. No. 3,748,015. An Offner imaging system is a catoptic system with unit magnification and high resolution provided by convex and concave spherical mirrors arranged with their centers of curvature at a single point. Such systems use reflective optical elements configured to substantially eliminate spherical aberration, coma, and distortion. They are also free from third order astigmatism and field curvature. In practice, some flexibility in the magnification of an Offner system is possible: magnification of approximately 1.2:1 can be used without excessively degrading optical performance.

However, if used without modification, the traditional Offner imaging system simply re-images aberrant light from an object. The present invention solves this problem with a dual Offner system. A first Offner system replaces lens 4 of system 100, i.e. it re-images light reflected from a wafer being tested onto a slit that performs a spatial filtering function. A second Offner system replaces lens 6, and serves to re-image the spatially filtered light to the entrance aperture of a one-dimensional imaging system, which then disperses the light into its constituent wavelengths for subsequent analysis. In combination, this dual Offner system provides near defect free image light to the one-dimensional imaging system, thus essentially stripping the recorded image of aberrations.

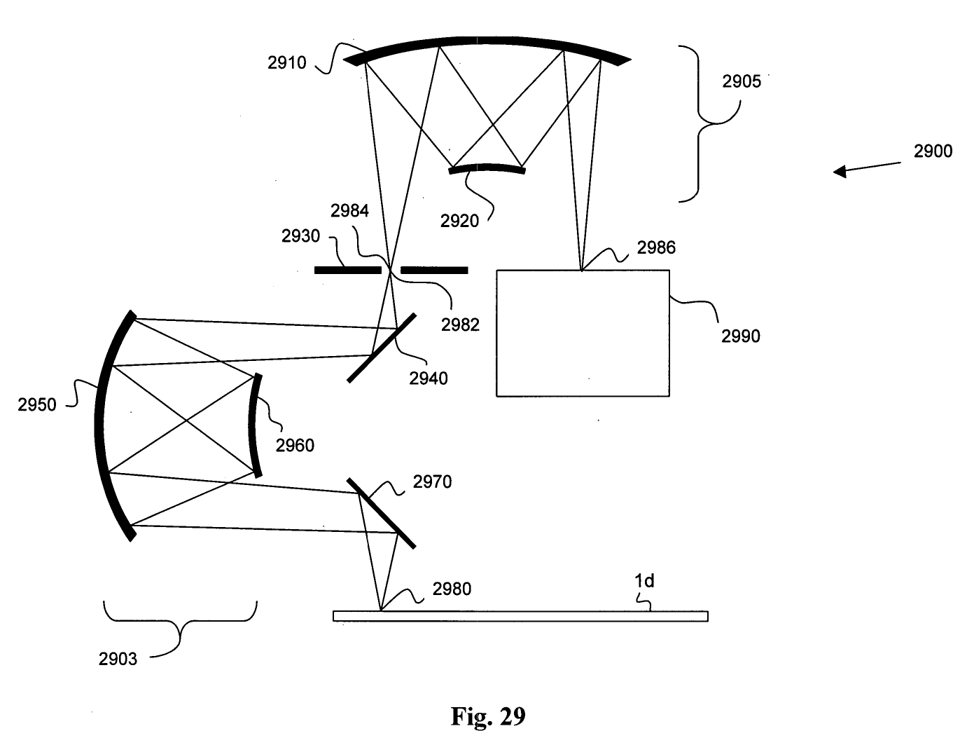

FIG. 29 shows one embodiment of a dual Offner imaging system 2900 according to the present invention that includes a folding mirror 2970, a first Offner group 2903, a folding mirror 2940, a slit 2930, a second Offner group 2905, and a one-dimensional imaging system 2990 having an entrance aperture.

Folding mirror 2970 and folding mirror 2940 are front surface mirrors that serve to fold the optical path of light emanating from wafer 1d to reduce the size of dual Offner imaging system 2900. Slit 2930 is an adjustable mechanical assembly having a pair of straight edges opposing each other and adjustable to maintain a fixed distance between the straight edges. One-dimensional imaging system 2990 has an entrance aperture that receives light. Light entering the aperture along an axis parallel to the direction of propagation is dispersed within one-dimensional imaging system 2990 to form a spatial-spectral image.

First Offner group 2903 includes a convex mirror 2960 and a concave mirror 2950, both of which have a radius of curvature and common center of curvature. Convex mirror 2960 and concave mirror 2950 are disposed within system 2900 so that their focal points are coincident. First Offner group 2903 has a first focal point 2980 and a second focal point 2982.

Second Offner group 2905 includes a convex mirror 2920 and a concave mirror 2910, both of which have a radius of curvature and a common center of curvature. Convex mirror 2920 and concave mirror 2910 are disposed within system 2900 so that their focal points are coincident. Second Offner group 2905 has a first focal point 2984 and a second focal point 2986. Second Offner group 2905 is disposed within system 2900 so that focal point 2982 and focal point 2984 coincide within slit 2930. Focal point 2986 is disposed within system 2900 at the entrance aperture of one-dimensional imaging system 2990.

In operation, wafer 1d is positioned within system 2900 so that portions of wafer 1d that include one or more measurement test sites pass through focal point 2980 of first Offner group 2903. Mirror 2970 reflects light reflected from wafer 1d at focal point 2980 and directs it toward concave mirror 2950 whereupon it is reflected toward convex mirror 2960. The light then undergoes a reflection back toward concave mirror 2950, and in so doing it starts to converge. The light reflects off concave mirror 2950 in a second reflection, and propagates to mirror 2940. The light then reflects off mirror 2940 and converges to focal point 2982. The blades of slit 2930, having been adjusted to approximately 10 um of separation, spatially filter the light passing through slit 2930. Once passing through focal point 2982 (and focal point 2984), the light diverges toward concave mirror 2910 of second Offner group 2905, which reflects the light toward convex mirror 2920. Upon reflection from convex mirror 3120, the light undergoes a second reflection from concave mirror 2910 before converging to focal point 2986. One-dimensional imaging system 2990 then receives the light and forms a spatial-spectral image of wafer 1d.

The absence of refractive optical elements in Offner groups 2903 and 2905 means that system 2900 is particularly well suited for use with UV light.

The various embodiments of the present invention have been described in the context of rectilinear wafer motion. Though such motion is often accomplished using linear translation stages, other mechanisms such as R-θ stages can also be used. Advantageously, R-θ stages also allow the overall system footprint of a given embodiment to be reduced compared to the system footprint using linear translation stages. Implementing system 100, system 101, system 102, system 103, system 104, or system 105 with R-θ stages involves moving one or both of optical system 11 wafer 1d with the R-θ stage.

It should also be clear that the methods and embodiments of the present invention can be used to measure film properties on all or on only a portion of a wafer or other structure having a stack of thin films.

Additional advantages and modifications will readily occur to those of skill in the art. The invention in the broader aspects is not, therefore, limited to the specific details, representative methods, and illustrative examples shown and described. Accordingly, departures may be made from such details without departing from the spirit or scope of the general inventive concept, and the invention is not to be restricted except in light of the appended claims and their equivalents.

1. An apparatus for correcting for second order diffraction errors in reflectance spectra, comprising:
a diffraction grating for diffracting light;
a detector for receiving the diffracted light, the detector having a minimum wavelength sensitivity and a cutoff wavelength;
a spectral source for illuminating the diffraction grating; and
a processor coupled to the detector for
recording at least one first-order reflectance intensity;
recording at least one second-order reflectance intensity;
calculating a ratio of the first-order reflectance intensity to the second-order reflectance intensity; and
calculating a wavelength-dependent correction factor from the ratio for any wavelength ranging from twice the minimum wavelength to the cutoff wavelength.

2. The apparatus of claim 1 wherein the spectral source emits a spectral source wavelength between the minimum wavelength and one-half of the cutoff wavelength.

3. The apparatus of claim 2 wherein the processor records the first-order reflectance intensity at the spectral source wavelength.

4. The apparatus of claim 1 wherein the spectral source comprises an illuminated patterned wafer.

5. An apparatus for measuring one or more properties of a patterned wafer, comprising:
a diffraction grating for diffracting light;
a detector for receiving the diffracted light, the detector having a minimum wavelength sensitivity and a cutoff wavelength;
a light source for illuminating the diffraction grating with light reflected from the wafer; and
a processor coupled to the detector for
recording at least one first-order reflectance intensity at a wavelength emitted from the reflected light;
recording at least one second-order reflectance intensity;
calculating a ratio of the first-order reflectance intensity to the second-order reflectance intensity;
calculating a wavelength-dependent correction factor from the ratio for any wavelength ranging from twice the minimum wavelength to the cutoff wavelength;
correcting the recorded at least one first order reflectance intensity according to the correction factor; and
determining from the corrected reflectance intensity one or more properties of the wafer.

6. The apparatus of claim 5 wherein the reflected light has a wavelength between the minimum wavelength and one-half of the cutoff wavelength.

7. The apparatus of claim 6 wherein the processor records the first-order reflectance intensity at the reflected light wavelength.

8. The apparatus of claim 5 further comprising a means for directing the light to one or more desired measurement locations on the wafer, and a processor for determining the one or more properties of the wafer at the one or more desired measurement locations.

9. The apparatus of claim 8 wherein the processor determines the one or more properties by comparing a modeled reflectance intensity with a corrected intensity at or within an area surrounding the one or more desired measurement locations.

10. The apparatus of claim 9 wherein the processor varies one or more modeling assumptions until the corrected reflectance intensity and modeled reflectance intensity are within a predetermined tolerance.

11. The apparatus of claim 9 wherein the processor varies the one or more desired measurement locations until the corrected reflectance intensity and modeled reflectance intensity are within a predetermined tolerance.

12. The apparatus of claim 5 wherein the one or more desired properties comprises film thickness.

13. The apparatus of claim 5 wherein the one or more properties comprises an optical constant.

14. The apparatus of claim 5 wherein the one or more properties comprises a doping density.

15. The apparatus of claim 5 wherein the one or more properties comprises a refractive index.

16. The apparatus of claim 8 wherein the processor determines an extinction coefficient at the one or more desired measurement locations.

17. The apparatus of claim 5 configured to obtain corrected reflectance intensities for successive one dimensional patterns of contiguous spatial locations along the wafer surface in the shape of a line.

18. The apparatus of claim 17 configured to aggregate the reflectance intensities from successive lines to form reflectance spectra for a two dimensional area.

19. A method for correcting for second order diffraction errors in reflectance spectra, comprising:
providing a diffraction grating for diffracting light;
providing a detector for receiving the diffracted light, the detector having a minimum wavelength sensitivity and a cutoff wavelength;
illuminating the diffraction grating with a spectral source;
recording at least one first-order reflectance intensity;
recording at least one second-order reflectance intensity;
calculating a ratio of the first-order reflectance intensity to the second-order reflectance intensity; and
calculating a wavelength-dependent correction factor from the ratio for any wavelength ranging from twice the minimum wavelength to the cutoff wavelength.

20. The method of claim 19 wherein the spectral source emits a spectral source wavelength between the minimum wavelength and one-half of the cutoff wavelength.

21. The method of claim 20 further comprising recording the first-order reflectance intensity at the spectral source wavelength.

22. The method of claim 19 wherein the spectral source comprises an illuminated patterned wafer.

23. A method for measuring one or more properties of a patterned wafer, comprising:
providing a diffraction grating for diffracting light;
providing a detector for receiving the diffracted light, the detector having a minimum wavelength sensitivity and a cutoff wavelength;
directing light to the wafer;
illuminating the diffraction grating with light reflected from the wafer;
recording at least one first-order reflectance intensity at a wavelength emitted from the reflected light;
recording at least one second-order reflectance intensity;
calculating a ratio of the first-order reflectance intensity to the second-order reflectance intensity;
calculating a wavelength-dependent correction factor from the ratio for any wavelength ranging from twice the minimum wavelength to the cutoff wavelength;
correcting the recorded at least one first order reflectance intensity according to the correction factor; and
determining from the corrected reflectance intensity one or more properties of the wafer.

24. The method of claim 23 wherein the reflected light has a wavelength between the minimum wavelength and one-half of the cutoff wavelength.

25. The method of claim 24 further comprising recording the first-order reflectance intensity at the reflected light wavelength.

26. The method of claim 23 further comprising directing the light to one or more desired measurement locations on the wafer and determining the one or more properties of the wafer at the one or more desired measurement locations.

27. The method of claim 26 further comprising determining the one or more properties by comparing a modeled reflectance intensity with a corrected intensity at or within an area surrounding the one or more desired measurement locations.

28. The method of claim 27 further comprising varying one or more modeling assumptions until the corrected reflectance intensity and modeled reflectance intensity are within a predetermined tolerance.

29. The method of claim 27 further comprising varying the one or more desired measurement locations until the corrected reflectance intensity and modeled reflectance intensity are within a predetermined tolerance.

30. The method of claim 23 wherein the one or more desired properties comprises film thickness.

31. The method of claim 23 wherein the one or more properties comprises an optical constant.

32. The method of claim 23 wherein the one or more properties comprises doping density.

33. The method of claim 23 wherein the one or more properties comprises a refractive index.

34. The method of claim 26 further comprising determining an extinction coefficient at the one or more desired measurement locations.

35. The method of claim 23 further comprising obtaining corrected reflectance intensities for successive one dimensional patterns of contiguous spatial locations along the wafer surface in the shape of a line.

36. The method of claim 35 further comprising aggregating the reflectance intensities from successive lines to form reflectance spectra for a two dimensional area.

37. A method for aligning an image of a patterned wafer, comprising:
(a) providing the image in an initial alignment;
(b) assigning an initial alignment angle;
(c) determining a Goodness of Alignment value for the alignment angle;
(d) rotating the image by an incremental angle to a new alignment angle;
(e) repeating steps (c) and (d) until a desired angle is achieved; and
(f) identifying a maximum Goodness of Alignment value and an optimal alignment angle corresponding to the maximum Goodness of Alignment value.

38. The method of claim 37 wherein the desired angle is a predetermined angle.

39. The method of claim 37 wherein the desired angle is an angle corresponding to a desired Goodness of Alignment value.

40. The method of claim 37 wherein the incremental angle is fixed.

41. The method of claim 37 wherein the incremental angle is a function of a previously determined Goodness of Alignment value.

42. The method of claim 37 wherein the provided image comprises a plurality of rows of reflectance measurements.

43. The method of claim 42 wherein each row comprises a one dimensional succession of reflectance intensities corresponding to spatial locations along the wafer.

44. The method of claim 43 wherein the spatial locations are in the shape of a line.

45. The method of claim 43 wherein the determining step further comprises determining the Goodness of Alignment value according to the one or more reflectance intensities.

46. The method of claim 42 wherein the determining step further comprises:
summing reflectance measurements in two or more rows to form a column of row sums;
detecting the contrast between one or more pairs of adjacent row sums; and
computing the Goodness of Alignment value for each alignment angle according to the detected contrast.

47. The method of claim 46 wherein the detecting step further comprises calculating difference values between one or more pairs of adjacent row sums, and the Goodness-of-Alignment value is computed by summing the difference values.

48. The method of claim 46 wherein the detecting step further comprises mathematical analysis of the column of row sums.

49. The method of claim 48 wherein the analysis comprises integrating a Fourier transform of the row sums.

50. A method for aligning an image of a patterned wafer, comprising:
directing light to the wafer;
receiving, in a line imaging spectrometer, light reflected from a plurality of one-dimensional spatial locations on the wafer;
producing a spectral image of the wafer from the reflected light, the spectral image comprising a plurality of rows of reflectance measurements corresponding to the one-dimensional spatial locations;
assigning an initial alignment angle of the spectral image;
determining a Goodness of Alignment value for the alignment angle;
rotating the image by an incremental angle to a new alignment angle;
repeating the determining and rotating steps until a desired alignment angle is achieved; and
identifying a maximum Goodness of Alignment value and an optimal alignment angle corresponding to the maximum Goodness of Alignment value.

51. The method of claim 50 wherein the desired angle is a predetermined angle.

52. The method of claim 50 wherein the desired angle is an angle corresponding to a desired Goodness of Alignment value.

53. The method of claim 50 wherein the incremental angle is fixed.

54. The method of claim 50 wherein the incremental angle is a function of a previously determined Goodness of Alignment value.

55. The method of claim 50 wherein one or more of the one dimensional spatial locations comprise a straight line.

56. The method of claim 50 wherein the determining step further comprises determining the Goodness of Alignment value according to one or more intensities of the reflectance measurements.

57. The method of claim 50 wherein the determining step further comprises:
summing reflectance measurements in two or more rows to form a column of row sums;
detecting the contrast between one or more pairs of adjacent row sums; and
computing the Goodness of Alignment value for each alignment angle according to the detected contrast.

58. The method of claim 57 wherein the detecting step further comprises calculating difference values between one or more pairs of adjacent row sums, and the Goodness-of-Alignment value is computed by summing the difference values.

59. The method of claim 57 wherein the detecting step further comprises mathematical analysis of the column of row sums.

60. The method of claim 59 wherein the analysis comprises integrating a Fourier transform of the row sums.

61. The method of claim 50 wherein the reflected light is received at the line imaging spectrometer via a dual Offner group apparatus.

62. An apparatus for producing a line image of a portion of a patterned wafer comprising:
a first Offner group having a first focal point and a second focal point, the first focal point coinciding with the portion of the patterned wafer;
a second Offner group having a third focal point and a fourth focal point, the third focal point coinciding with the second focal point;
a slit having two straight edges separated by a distance, the slit disposed in a plane perpendicular to the direction of propagation of light at the second focal point; and
a one-dimensional imaging system having a focal plane disposed at the fourth focal point.

63. The apparatus of claim 62 further comprising a folding mirror disposed between the first focal point and the first Offner group.

64. The apparatus of claim 62 further comprising a folding mirror disposed between the second focal point and the first Offner group.

65. The apparatus of claim 62 wherein the second Offner group transmits the portion of the patterned wafer as a line image to the fourth focal point.

66. The apparatus of claim 65 wherein the line image comprises a one dimensional pattern of spatial locations of the portion of the patterned wafer.

67. The apparatus of claim 66 wherein the one dimensional imaging system determines from the line image a reflectance spectrum for one or more of the spatial locations.

68. The apparatus of claim 65 further comprising a processor coupled to the one dimensional imaging system for determining from the line image one or more properties of the patterned wafer.

69. The apparatus of claim 68 wherein the processor aggregates the reflectance spectra to obtain a spectral image of a portion of the wafer.

70. A method for producing a line image of a portion of a patterned wafer, comprising:
illuminating the patterned wafer;
positioning a first Offner group having a first focal point and a second focal point such that the first focal point coincides with the portion of the patterned wafer;
positioning a second Offner group having a third focal point and a fourth focal point such that the third focal point coincides with the second focal point;
positioning a slit in a plane perpendicular to a direction of propagation of light at the second focal point, the slit having two straight edges separated by a distance; and
positioning a one-dimensional imaging system having a focal plane disposed at the fourth focal point.

71. The method of claim 70 further comprising positioning a folding mirror between the first focal point and the first Offner group.

72. The method of claim 70 further comprising positioning a folding mirror between the second focal point and the first Offner group.

73. The method of claim 70 wherein the second Offner group transmits the portion of the patterned wafer as a line image to the fourth focal point.

74. The method of claim 73 wherein the line image comprises a one dimensional pattern of spatial locations of the portion of the patterned wafer.

75. The method of claim 74 further comprising the one dimensional imaging system determining from the line image a reflectance spectrum for one or more of the spatial locations.

76. The method of claim 73 further comprising determining from the line image one or more properties of the patterned wafer.

77. The method of claim 76 further comprising aggregating the reflectance spectra to obtain a spectral image of the portion of the patterned wafer.
